(19) United States
(12) Patent Application Publication
(10) Pub. No.: US 2024/0421486 A1
(43) Pub. Date: Dec. 19, 2024

(54) ANTENNA UNIT AND WINDOWPANE

(71) Applicant: AGC Inc., Tokyo (JP)

(72) Inventors: Mayu OGAWA, Chiyoda-ku (JP); Ryuta SONODA, Chiyoda-ku (JP)

(73) Assignee: AGC Inc., Tokyo (JP)

(21) Appl. No.: 18/811,934

(22) Filed: Aug. 22, 2024

Related U.S. Application Data
(63) Continuation of application No. PCT/JP2023/007963, filed on Mar. 3, 2023.

(30) Foreign Application Priority Data
Mar. 8, 2022 (JP) 2022-035030

(51) Int. Cl. H01Q 9/04; H01Q 21/06

(52) U.S. Cl. CPC H01Q 9/0407; H01Q 21/065

(57) ABSTRACT

An antenna unit includes a dielectric layer through which visible light transmits, a first conductor layer, a pseudo layer, and a second conductor layer provided separately from the first conductor layer. At least part of the pseudo layer is disposed around the second conductor layer in a plan view. The inequality |n₁−n₂|/N≤1.09×10⁻¹ holds where n₁ and n₂ (n₁ and n₂ are integers equal to or larger than zero) are N-level gradation values (N is a natural number) in a case where a first region that exists without overlapping the second conductor layer in the pseudo layer and a second region that exists without overlapping the pseudo layer in the second conductor layer, respectively, in the plan view are read at a resolution of 400 dpi.

### INCORPORATION BY REFERENCE

This application is based upon and claims the benefit of priority from Japanese Patent Application 2022-035030 filed on Mar. 8, 2022, and PCT application No. PCT/JP2023/007963 filed on Mar. 3, 2023, the disclosure of which is incorporated herein in its entirety by reference.

### BACKGROUND

The present invention relates to an antenna unit and a window glass.

An antenna unit including a mesh-like antenna conductor and a mesh-like ground conductor used for a window glass of a building, an automobile, or the like is known (for example, International Patent Publication No. WO2020/095786).

### SUMMARY

Mesh-like patterns of the antenna conductor and the ground conductor described above in Patent Literature 1 are formed on part of a substrate and thus are conspicuous when the substrate is visually recognized. Accordingly, an antenna unit with inconspicuous patterns and improved design is desired.

The present invention is made in view of the above-described problem and intended to provide an antenna unit and a window glass with excellent design.

An aspect of the present invention provides an antenna unit having configurations [1] to [13] below.

[1] An antenna unit comprising:
a dielectric layer through which visible light transmits;
a first conductor layer;
a pseudo layer; and
a second conductor layer provided separately from the first conductor layer, wherein
the first conductor layer is provided on a first principal surface side of the dielectric layer with respect to the dielectric layer,
the second conductor layer is provided on the first principal surface side of the dielectric layer or a second principal surface side opposite to the first principal surface side with respect to the dielectric layer,
at least part of the pseudo layer is disposed around the second conductor layer in a plan view, and
   |n₁−n₂|/N≤1.09×10⁻¹ holds where n₁ and n₂ (n₁ and n₂ are integers equal to or larger than zero) are N-level gradation values (N is a natural number) in a case where a first region that exists without overlapping the second conductor layer in the pseudo layer and a second region that exists without overlapping the pseudo layer in the second conductor layer in the plan view are read at a resolution of 400 dpi.

[2] The antenna unit according to [1], wherein |n₁−n₂|/N≤6.25×10⁻² holds.

[3] The antenna unit according to [1] or [2], where N=256 and n₂≤246 hold.

[4] The antenna unit according to any one of [1] to [3], wherein

The first conductor layer includes a radiative conductor,
the second conductor layer includes a ground conductor, and
the second conductor layer is provided on the second principal surface side of the dielectric layer with respect to the dielectric layer.

[5] The antenna unit according to any one of [1] to [3], wherein
the first conductor layer includes a radiative conductor,
the second conductor layer includes a ground conductor, and
the second conductor layer is provided on the first principal surface side of the dielectric layer with respect to the dielectric layer.

[6] The antenna unit according to any one of [1] to [3], wherein
the first conductor layer includes a ground conductor,
the second conductor layer includes a radiative conductor, and
the second conductor layer is provided on the second principal surface side of the dielectric layer with respect to the dielectric layer.

[7] The antenna unit according to any one of [1] to [3], wherein
the first conductor layer includes a radiative conductor,
the second conductor layer includes a waveguide element that guides electric waves radiated by the radiative conductor in a predetermined direction,
the second conductor layer is provided on the second principal surface side of the dielectric layer with respect to the dielectric layer, and
the antenna unit further includes a ground conductor layer provided on a side opposite to the dielectric layer with respect to the first conductor layer.

[8] The antenna unit according to any one of [1] to [7], wherein the pseudo layer includes a pattern in which array elements are arrayed separately from each other.

[9] The antenna unit according to [8], wherein the array element has an electrical conductivity equal to or larger than 1×10⁶ (S/m).

[10] The antenna unit according to [9], wherein
the array elements each have a circular shape, and
the array elements have an average diameter equal to or smaller than λ₀/2 where λ₀ is a free-space wavelength of electric waves transmitted and received by the antenna unit.

[11] The antenna unit according to [9], wherein
the array elements each have a rectangular shape, and
the array elements each have a long side of a length equal to or smaller than λ₀/2 where λ₀ is a free-space wavelength of electric waves transmitted and received by the antenna unit.

[12] The antenna unit according to any one of [1] to [7], wherein
the pseudo layer is made of an insulator, and
the insulator has an electrical conductivity smaller than 1×10⁶ (S/m).

[13] The antenna unit according to any one of 11] to [12], wherein the second conductor layer includes a mesh-like conductor pattern.

Another aspect of the present invention provides a window glass including an antenna unit having any of the configurations [1] to [13].

### Advantageous Effects of Invention

According to an aspect of the present invention, it is possible to provide an antenna unit and a window glass with excellent design.

The above and other objects, features and advantages of the present disclosure will become more fully understood from the detailed description given hereinbelow and the accompanying drawings.

### BRIEF DESCRIPTION OF DRAWINGS

FIG. 1 is a top drawing of a window glass according to a first embodiment;

FIG. 2 is a top drawing of an antenna unit according to the first embodiment;

FIG. 3 is a plan drawing of the antenna unit according to the first embodiment;

FIG. 4 is a diagram illustrating a radiation element layer, a ground conductor layer, and a pseudo layer formed in a dielectric layer of the antenna unit according to the first embodiment in a plan view;

FIG. 5 is an enlarged plan drawing of a boundary region A1 according to the first embodiment;

FIG. 6A is a diagram for description of an example of homogenization processing according to the first embodiment;

FIG. 6B is a diagram for description of an example of the homogenization processing according to the first embodiment;

FIG. 7 is a top drawing of an antenna unit according to Configuration Example 1 of a second embodiment;

FIG. 8 is a diagram illustrating a radiation element layer, a ground conductor layer, and a pseudo layer formed in the dielectric layer of the antenna unit according to Configuration Example 1 of the second embodiment in a plan view;

FIG. 9 is a diagram illustrating a radiation element layer, a ground conductor layer, and a pseudo layer formed in the dielectric layer of an antenna unit according to Configuration Example 2 of the second embodiment in a plan view;

FIG. 10 is a top drawing of an antenna unit according to Configuration Example 3 of the second embodiment;

FIG. 11 is a cross-sectional view of an antenna unit according to a third embodiment;

FIG. 12 is a plan drawing of the antenna unit according to the third embodiment;

FIG. 13 is a diagram illustrating a radiation element layer, a waveguide layer, and a pseudo layer formed in the dielectric layer of the antenna unit according to the third embodiment in a plan view;

FIG. 14 is a cross-sectional view of a modification of the antenna unit according to the third embodiment;

FIG. 15 is a top drawing of an antenna unit according to a fourth embodiment;

FIG. 16 is a plan drawing of an antenna unit according to a fifth embodiment;

FIG. 17 is a cross-sectional view of the antenna unit according to the fifth embodiment;

FIG. 18 is a cross-sectional view of the antenna unit according to the fifth embodiment;

FIG. 19 is a diagram illustrating the relation between (dot diameter/dot pitch) and a gradation value;

FIG. 20 is a diagram illustrating the relation between (mesh line width/mesh pitch) and the gradation value;

### DESCRIPTION OF EMBODIMENTS

Specific embodiments to which the present invention is applied will be described below in detail with reference to the accompanying drawings. For clear explanation, the following description and drawings are omitted and simplified as appropriate. In the drawings, identical elements are denoted by the same reference sign, and duplicate description thereof is omitted as necessary. Note that, in each embodiment, deviations that do not compromise advantageous effects of the present invention are allowed in directions such as parallel, horizontal, and vertical directions. In addition, an X-axis direction, a Y-axis direction, and a Z-axis direction are a direction parallel to an X axis, a direction parallel to a Y axis, and a direction parallel to a Z axis, respectively. The X-axis direction, the Y-axis direction, and the Z-axis direction are orthogonal to one another. An XY plane, a YZ plane, and a ZX plane are a plane parallel to the X-axis direction and the Y-axis direction, a plane parallel to the Y-axis direction and the Z-axis direction, and a plane parallel to the Z-axis direction and the X-axis direction, respectively.

In the present embodiment, “plan view” and “plan drawing” mean viewing of the XY plane or the XY plane itself, respectively. In addition, in the present embodiment, “top view” and “top drawing” mean viewing of the ZX plane or the ZX plane itself, respectively.

In the present embodiment, deviations that do not compromise advantageous effects of the present invention are allowed in “the same plane”.

An “antenna unit” in the present embodiment is used for propagation of signals in a predetermined frequency band. In the following description, the predetermined frequency band is referred to as a target frequency band in some cases. The target frequency band may be a frequency band from 4G Long Term Evolution (LTE) to 5G and may be, for example, a frequency band of 700 MHz to 6 GHz (what is called sub6), but is not limited thereto. Specifically, the target frequency band may be a frequency band lower than 700 MHz, a frequency band higher than 6 GHz such as a 28 GHz band, or a frequency band called millimeter wave, which is higher than 30 GHz such as a 79 GHz band. The antenna unit may be used in accordance with, for example, a wireless communication standard such as 5G or Bluetooth (registered trademark) or a wireless local area network (LAN) standard such as IEEE802.11ac. When used on a vehicle, the antenna unit may be used in an on-board radar system, a V2X communication system, or a dedicated short-range communications (DSRC) system. The antenna unit may comply with any other standard.

### <Embodiment Overview>

First, an overview of an embodiment to be described later will be described below. An antenna unit according to the present embodiment includes a dielectric layer through which visible light transmits, a first conductor layer, a pseudo layer, and a second conductor layer.

The first conductor layer is a layer provided on a first principal surface side of the above-described dielectric layer with respect to the dielectric layer.

The second conductor layer is a layer provided separately from the first conductor layer by a predetermined distance in a top view. The second conductor layer is provided on the first principal surface side of the dielectric layer or a second principal surface side with respect to the dielectric layer. The second principal surface is a principal surface opposite to the first principal surface among principal surfaces of the dielectric layer.

At least part of the pseudo layer is disposed around the second conductor layer in a plan view.

A first region is defined as a region of the pseudo layer where the pseudo layer exists without overlapping the second conductor layer in a plan view. In addition, a second region is defined as a region of the second conductor layer where the second conductor layer exists without overlapping the pseudo layer. N-level gradation values of the first region and the second region when the first region and the second region are read at a resolution of 400 dpi represented by n₁ and n₂, respectively. The number N is a natural number and n₁ and n₂ are integers equal to or larger than zero. A value obtained by normalizing the absolute value of the difference between the gradation values, namely |n₁−n₂|/N is equal to or larger than 0 and equal to or smaller than 1.09×10⁻¹.

In the antenna unit according to the present embodiment, at least part of the pseudo layer is disposed around the second conductor layer and the difference between the gradation values of the first region and the second region is small, and accordingly, the second conductor layer is inconspicuous with the pseudo layer. Thus, design can be improved.

The antenna unit will be specifically described in first to fifth embodiments below.

### First Embodiment

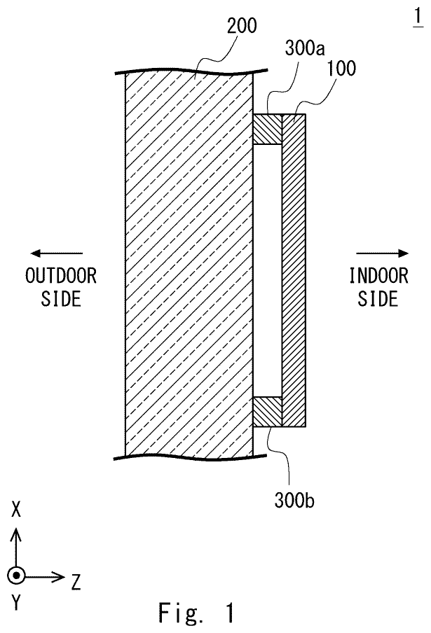

First, a first embodiment of the present invention will be described. FIG. 1 is a top drawing of a window glass 1 according to the first embodiment. The window glass 1 is a window glass attached to a building or a vehicle. The window glass 1 includes a window glass body 200, an antenna unit 100, and support parts 300a and 300b.

The window glass body 200 is a transparent plate member through which visible light transmits. In FIG. 1, the window glass body 200 has principal surfaces parallel to the XY plane and has a thickness direction parallel to the Z-axis direction. Note that the positive Z-axis direction points to an indoor side, and the negative Z-axis direction points to an outdoor side. The window glass body 200 is a dielectric member containing a dielectric as a primary component. The material of the window glass body 200 is glass but may be resin.

The antenna unit 100 is a plate, sheet, or film member provided on the principal surface of the window glass body 200 on the indoor side with the support parts 300a and 300b interposed therebetween. In the present diagram, the antenna unit 100 is provided along the principal surface of the window glass body 200. The antenna unit 100 transmits and receives electric waves in a target frequency band. The antenna unit 100 is a planar antenna and is, for example, a patch antenna, a micro strip antenna, or a slot antenna.

The support parts 300a and 300b are members that support the antenna unit 100 to the window glass body 200. The support parts 300a and 300b support the antenna unit 100 such that a space is formed between the window glass body 200 and the antenna unit 100. Note that the support parts 300a and 300b may support the antenna unit 100 such that the window glass body 200 contacts a principal surface of the antenna unit 100, but preferably support the antenna unit 100 such that the space is formed as illustrated in FIG. 1 to lower the risk of thermal cracking. In this case, the support parts 300a and 300b may be spacers for ensuring the space between the window glass body 200 and the antenna unit 100 or may be a housing of the antenna unit 100.

The material of the support parts 300a and 300b may be a dielectric. The material of the support parts 300a and 300b may be, for example, resin such as silicone resin, polysulfide resin, or acrylic resin. Alternatively, the material of the support parts 300a and 300b may be metal such as aluminum.

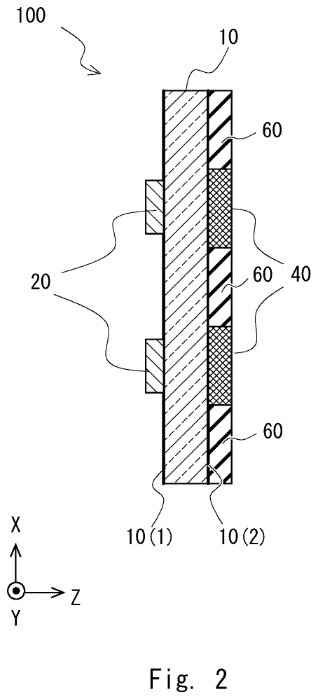

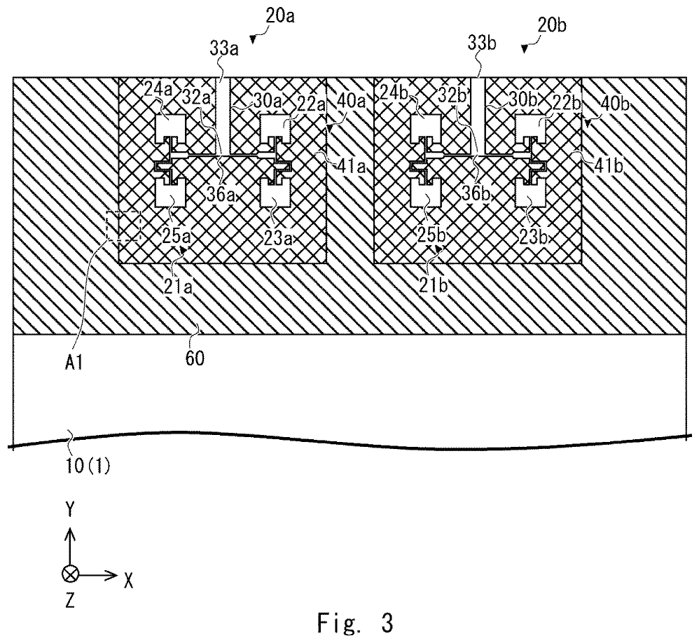

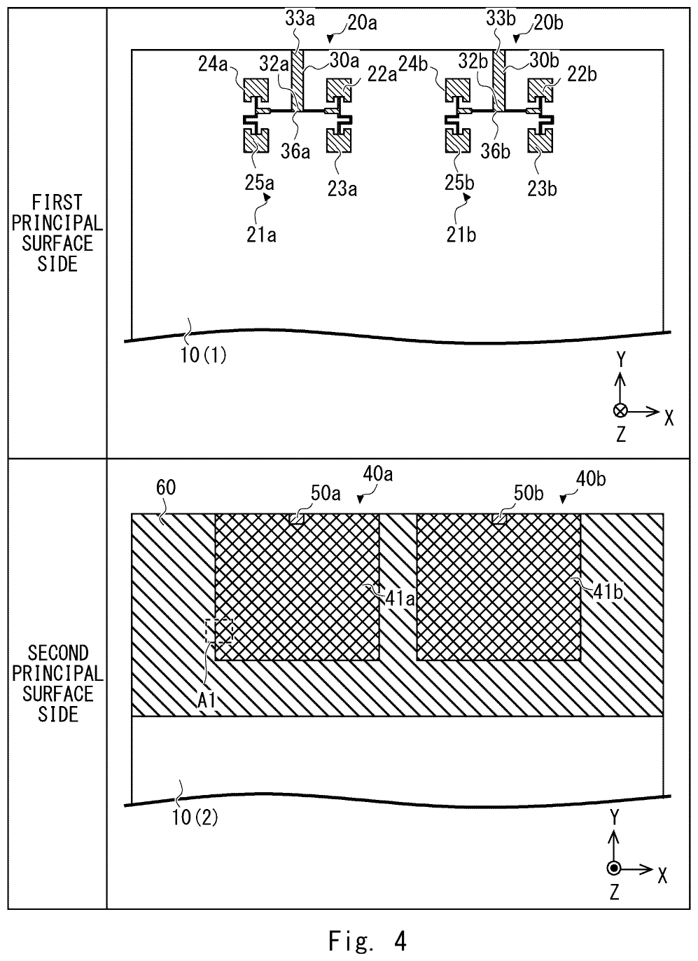

FIG. 2 is a top drawing of the antenna unit 100 according to the first embodiment. FIG. 3 is a plan drawing of the antenna unit 100 according to the first embodiment. FIG. 3 illustrates the XY plane when viewed in the negative Z-axis direction. The antenna unit 100 includes a dielectric layer 10, a radiation element layer 20, a pseudo layer 60, and a ground conductor layer 40 as examples of the dielectric layer, the first conductor layer, the pseudo layer, and the second conductor layer, respectively, described above in the overview. FIG. 4 is a diagram illustrating the radiation element layer 20, the ground conductor layer 40, and the pseudo layer 60 formed in the dielectric layer 10 of the antenna unit 100 according to the first embodiment in a plan view. FIG. 4 illustrates a plan drawing seen from the first principal surface side and a plan drawing seen from the second principal surface side.

As illustrated in FIG. 2, the dielectric layer 10 is a transparent plate, sheet, or film member through which visible light transmits. The dielectric layer 10 contains a dielectric as a primary component. The material of the dielectric layer 10 may be glass, ceramic, or resin. Examples of the dielectric layer 10 include a glass substrate, acrylic, polycarbonate, polyvinyl butyral (PVB), cycloolefin polymer (COP), polyethylene terephthalate (PET), polyimide, ceramic, and sapphire. In a case where the dielectric layer 10 is a glass substrate, the material thereof is, for example, alkali-free glass, quartz glass, soda-lime glass, borosilicate glass, alkali borosilicate glass, or aluminosilicate glass.

The visible light transmittance of the dielectric layer 10 is, for example, preferably 30% or higher, more preferably 50% or higher, even more preferably 70% or higher, particularly preferably 80% or higher, and most preferably 90% or higher. The visible light transmittance is measured in accordance with JIS R 3106 (1998).

The dielectric layer 10 has principal surfaces parallel to the XY plane like the window glass body 200 and has a thickness direction parallel to the Z axis. In the following description, the principal surface of the dielectric layer 10 in the negative Z-axis direction is also referred to as a first principal surface 10(1), and the principal surface of the dielectric layer 10 in the positive Z-axis direction is also referred to as a second principal surface 10(2).

Accordingly, the second principal surface 10(2) is a principal surface opposite to the first principal surface 10(1).

The radiation element layer 20 is a layer including a radiative conductor and formed to be able to transmit and receive electric waves in the above-described target frequency band. The radiation element layer 20 is provided on the first principal surface 10(1) side of the dielectric layer 10 with respect to the dielectric layer 10, in other words, the negative Z-axis direction side with respect to the dielectric layer 10. In the first embodiment, specifically, the radiation element layer 20 is formed on at least a partial region of the first principal surface 10(1) of the dielectric layer 10 such that surfaces thereof are parallel to the XY plane.

The ground conductor layer 40 is a layer including a ground conductor forming a ground surface. The ground conductor layer 40 is provided corresponding to the radiation element layer 20. The ground conductor layer 40 is conspicuous in appearance in some cases, and thus in the first embodiment, the ground conductor layer 40 is camouflaged to be inconspicuous. In the first embodiment, the ground conductor layer 40 is provided on the second principal surface 10(2) side of the dielectric layer 10 with respect to the dielectric layer 10, in other words, the positive Z-axis direction side with respect to the dielectric layer 10. Specifically, the ground conductor layer 40 is formed on at least a partial region of the second principal surface 10(2) of the dielectric layer 10 such that surfaces thereof are parallel to the XY plane.

The pseudo layer 60 is a camouflage layer formed to make the ground conductor layer 40 inconspicuous. Similarly to the ground conductor layer 40, the pseudo layer 60 is provided on the second principal surface 10(2) side of the dielectric layer 10 with respect to the dielectric layer 10. More specifically, the pseudo layer 60 is formed on the same plane as the ground conductor layer 40. In other words, the pseudo layer 60 is formed on at least a partial region of the second principal surface 10(2) of the dielectric layer 10 such that surfaces thereof are parallel to the XY plane.

FIGS. 3 and 4 illustrate, as an example, a configuration (refer to “first principal surface side” in FIG. 4) in which two antenna elements 20a and 20b are formed in the radiation element layer 20 illustrated in FIG. 2. FIGS. 3 and 4 also illustrate a configuration (refer to “second principal surface side” in FIG. 4) in which two ground conductors 40a and 40b are formed in the ground conductor layer 40 illustrated in FIG. 2. The ground conductors 40a and 40b are provided corresponding to the antenna elements 20a and 20b, respectively. The antenna element 20a or the ground conductor 40a, and the antenna element 20b or the ground conductor 40b are arrayed separately from each other by a predetermined distance in the X-axis direction. Note that the numbers of antenna elements and ground conductors included in the antenna unit 100 are not limited to two but may be one or may be equal to or larger than three.

[Antenna Element 20a]

Details of the antenna element 20a will be described below. Note that the antenna element 20b is the same as the antenna element 20a and thus description thereof is omitted.

The antenna element 20a is a planar conductor pattern formed on the first principal surface 10(1) side. The material of a conductor used for the antenna element 20a is, for example, gold, silver, copper, platinum, aluminum, or chromium. The antenna element 20a may be a film formed by plating with the above-described material. By the plating, the antenna element 20a with resistance to corrosion and excellent design can be formed. Alternatively, the antenna element 20a may be obtained by sintering a pattern formed on the first principal surface 10(1) by using screen printing with paste of silver, copper, or the like.

The antenna element 20a may be formed directly on the first principal surface 10(1) or may be formed indirectly. For example, the antenna element 20a may be formed on the first principal surface 10(1) of the dielectric layer 10 with a resin layer interposed therebetween. For example, an intermediate film of polyvinyl butyral, ethylene-vinyl acetate, or the like, polyethylene terephthalate, or optically clear adhesive (OCA) may be used as the resin layer.

The antenna element 20a includes a radiative conductor 21a and a power supply line 30a.

The radiative conductor 21a includes at least one patch conductor. In the first embodiment, the radiative conductor 21a includes four patch conductors 22a, 23a, 24a, and 25a. The patch conductors 22a, 23a, 24a, and 25a may be made of solid planar conductors. However, the patch conductors 22a, 23a, 24a, and 25a are not limited thereto but may be made of mesh-like conductor patterns formed to have gaps in a plan view. In this case, a visual field can be ensured and design can be improved.

The power supply line 30a is a conductor pattern formed on the first principal surface 10(1) side. The power supply line 30a functions as a signal wire. In the first embodiment, the power supply line 30a is a strip conductor extending in the Y-axis direction. The power supply line 30a may be made of a solid planar conductor. However, the power supply line 30a is not limited thereto but may be made of a mesh-like conductor pattern formed to have gaps in a plan view. In this case, a visual field can be ensured and design can be improved.

In the first embodiment, the power supply line 30a is formed integrally with the radiative conductor 21a. The power supply line 30a is connected to the radiative conductor 21a at one edge portion 32a. More specifically, at the one edge portion 32a, the power supply line 30a includes a bifurcation path to the patch conductors 22a and 23a, a bifurcation path to the patch conductors 24a and 25a, and a bifurcation place 36a where these bifurcation paths are connected to each other. The power supply line 30a is also connected to a wireless apparatus such as a transmitter at the other edge portion 33a. The edge portion 33a of the power supply line 30a functions as a power supply edge. Note that the edge portion 33a coincides with an edge portion of the dielectric layer 10 in the positive Y-axis direction in the first embodiment, but may be separated from the edge portion of the dielectric layer 10 in the positive Y-axis direction by a predetermined distance in the negative Y-axis direction.

[Ground Conductor 40a]

Details of the ground conductor 40a will be described below. Note that the ground conductor 40b is the same as the ground conductor 40a and thus description thereof is omitted.

The ground conductor 40a is a planar conductor pattern formed on the second principal surface 10(2) side.

The material of a conductor used for the ground conductor 40a is, for example, gold, silver, copper, platinum, aluminum, or chromium. The ground conductor 40a may be a film formed by plating with the above-described material.

By the plating, the ground conductor 40a with resistance to corrosion and excellent design can be formed. Alternatively, the ground conductor 40a may be obtained by sintering a pattern formed on the second principal surface 10(2) by using screen printing with paste of silver, copper, or the like.

The ground conductor 40a may be formed directly on the second principal surface 10(2) or may be formed indirectly. For example, the ground conductor 40a may be formed on the second principal surface 10(2) of the dielectric layer 10 with a resin layer interposed therebetween. For example, an intermediate film of polyvinyl butyral, ethylene-vinyl acetate, or the like, polyethylene terephthalate, or OCA may be used as the resin layer.

The ground conductor 40a includes a linear ground conductor 41a formed to have gaps in a plan view and a planar ground conductor 50a connected to the linear ground conductor 41a.

The linear ground conductor 41a is a continuous pattern in which linear conductors are electrically connected to each other, specifically, a mesh-like conductor pattern. In other words, a region where the linear ground conductor 41a is formed includes lattice gaps in a plan view. Accordingly, a visual field can be ensured and design can be improved. The linear ground conductor 41a exists on the second principal surface 10(2) side such that at least part thereof overlaps the antenna element 20a in a plan view. For example, in the first embodiment, the linear ground conductor 41a is formed in a rectangular region. However, the shape of the region where the linear ground conductor 41a is formed is not limited thereto but may be any other polygonal or circular shape. Note that an edge portion of the linear ground conductor 41a in the positive Y-axis direction coincides with the edge portion of the dielectric layer 10 in the positive Y-axis direction in the first embodiment but may be separated from the edge portion of the dielectric layer 10 in the positive Y-axis direction by a predetermined distance in the negative Y-axis direction.

For example, an angle formed by the linear conductors of the linear ground conductor 41a is 90° approximately but not limited thereto and may be an acute angle or an obtuse angle. In other words, the mesh openings may be rectangular or rhombic. In a case where the mesh openings are rectangular, the mesh openings are preferably square from a viewpoint of design. Alternatively, the mesh openings may have any other polygonal shape, for example, a hexagonal shape. In a case where the mesh openings are hexagonal, the mesh openings are preferably regular hexagonal from a viewpoint of design. Alternatively, the mesh openings may have a random shape by a self-organization method.

The planar ground conductor 50a is a ground electrode corresponding to the edge portion 33a functioning as a power supply edge. Specifically, the planar ground conductor 50a is formed on the second principal surface 10(2) side at a position overlapping the edge portion 33a in a plan view. The planar ground conductor 50a is formed at the edge portion of the dielectric layer 10 in the positive Y-axis direction in the first embodiment but may be formed at a position separated from the edge portion of the dielectric layer 10 in the positive Y-axis direction by a predetermined distance in the negative Y-axis direction. The planar ground conductor 50a is formed of a solid pattern.

### [Pseudo Layer 60]

The pseudo layer 60 is disposed around a region where the ground conductor 40a is formed in a plan view without overlapping the region where the ground conductor 40a is formed. Being “disposed around” means being disposed in contact with at least part of the outer edge of the region where the ground conductor 40a is formed in a plan view. For example, in a case where the region where the ground conductor 40a is formed is rectangular, the pseudo layer 60 may be disposed in contact with and surrounding three sides of the rectangle other than an edge side in the positive Y-axis direction as illustrated in FIG. 4. However, the pseudo layer 60 is not limited thereto but may be disposed in contact with and surrounding all of the four sides of the rectangle. Alternatively, the pseudo layer 60 may be disposed in contact with one side or two sides of the rectangle. Note that “contact” may be direct contact but may include a gap to an extent that does not compromise effectiveness. If the gap is large, the boundary of the pseudo layer 60 and the ground conductor 40a is conspicuous.

The pseudo layer 60 preferably does not affect antenna performance but the size of the gap affects antenna performance in some cases. For example, in a case where the pseudo layer 60 is formed on the same plane as the ground conductor 40a as illustrated in FIGS. 2 to 4 and is formed of a conductor, antenna performance changes depending on the size of the gap. In this case, the gap may be equal to or larger than 20 μm and equal to or smaller than 300 μm when the gap is present. In a case where the gap is equal to or larger than 20 μm, influence of the pseudo layer 60 on antenna performance is small. In a case where the gap is equal to or smaller than 300 μm, the boundary of the pseudo layer 60 and the ground conductor 40a is inconspicuous. The gap is 30 μm, for example.

However, in a case where the pseudo layer 60 is formed on a plane different from that of the ground conductor 40a or in a case where the pseudo layer 60 is formed of an insulator, influence on antenna performance is sufficiently small irrespective of the size of the gap. Thus, in this case, the gap may be larger than 0 μm and equal to or smaller than 300 μm when the gap is present.

Note that a conductor is a conductive material having an electrical conductivity a equal to or larger than 1×10⁶ (S/m), and an insulator is a dielectric material having an electrical conductivity a smaller than 1×10⁶ (S/m).

In FIGS. 3 and 4, the ground conductor layer 40 includes the ground conductors 40a and 40b separated from each other in the X-axis direction, and the pseudo layer 60 is also disposed around the ground conductor 40b in a plan view. For example, the pseudo layer 60 may be disposed around the plurality of ground conductors 40a and 40b in a plan view to integrally connect the plurality of ground conductors 40a and 40b.

In this manner, the ground conductor layer 40 can be camouflaged when at least part of the pseudo layer 60 is disposed around the ground conductor layer 40 in a plan view. Accordingly, design can be improved. In a case where the plurality of ground conductors 40a and 40b separated from each other are formed in the ground conductor layer 40 of the antenna unit 100 as illustrated in FIGS. 3 and 4, the plurality of ground conductors 40a and 40b appear integrated, and thus particularly significant effects are achieved.

In FIGS. 3 and 4, the pseudo layer 60 is designed in a shape corresponding to a rectangular region as a whole together with a region where the ground conductor layer 40 is formed, but is not limited thereto and may be designed in a circular shape or any other shape. For example, the pseudo layer 60 may be designed in a shape corresponding to an optional pattern together with the region where the ground conductor layer 40 is formed. Accordingly, design can be further improved.

Note that an edge portion of the pseudo layer 60 in the X-axis direction may coincide with an edge portion of the dielectric layer 10 in the X-axis direction, but may be separated by a predetermined distance from the edge portion of the dielectric layer 10 in the X-axis direction. This is the same for edge portions in the Y-axis direction.

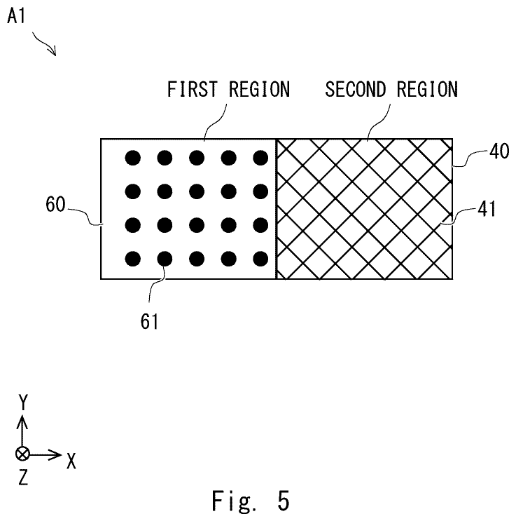

FIG. 5 is an enlarged plan drawing of a region A1 according to the first embodiment. As illustrated in FIGS. 3 and 4, the region A1 is a region including the boundary of the pseudo layer 60 and the ground conductor layer 40.

The pseudo layer 60 preferably has a structure with which scattering of electric waves is sufficiently small and that does not affect antenna performance. The pseudo layer 60 may be formed of a conductor or may be formed of an insulator. In a case where the pseudo layer 60 is an insulator, scattering of electric waves by the pseudo layer 60 is sufficiently small and influence on antenna characteristics is small. In a case where the pseudo layer 60 is formed of a conductor constituted by a plurality of conductors spatially separated, in other words, not conducted in a direct-current manner, scattering of electric waves by the pseudo layer 60 is small and influence on antenna characteristics is small.

In the first embodiment, the pseudo layer 60 includes a pattern in which conductor array elements 61 are arrayed separately from each other at a predetermined pitch. In FIG. 5, the array elements 61 are circular and dots in some cases. The diameter of each array element 61 is preferably equal to or smaller than λ₀/2 because scattering of electric waves can be reduced. The diameter of each array element 61 is more preferably equal to or smaller than λ₀/5 and even more preferably λ₀/10. As illustrated in FIG. 5, the array elements 61 may be disposed at positions where there occurs a predetermined gap to the ground conductor layer 40 in a plan view. As an example, the distance from the outer edge of the ground conductor layer 40 to the array elements 61 is 30 μm.

Note that each array element 61 may have a rectangular shape. In a case where each array element 61 has a rectangular shape, the length of each side, in particular, the length of each long side is preferably equal to or smaller than λ₀/2 because scattering of electric waves can be reduced. The length of each side of the rectangle, in particular, the length of each long side is more preferably equal to or smaller than λ₀/5, and even more preferably equal to or smaller than λ₀/10. The wavelength λ₀ is the wavelength of electric waves transmitted and received by the antenna unit 100 in free space. The rectangle includes oblongs and squares as well as chamfered oblongs and squares.

Alternatively, the shape of each array element 61 may be a rhombus, a triangle, a hexagon, any other polygon, a star, or any other shape.

The material of the conductor used for the array elements 61 is, for example, gold, silver, copper, platinum, aluminum, or chromium. From a viewpoint of manufacturing cost, the material of the conductor used for the array elements 61 is preferably the same material as that of the second conductor layer described above in the overview, in other words, the same material as that of the ground conductor layer 40 in the first embodiment. The pseudo layer 60 may be a film formed by plating with the above-described material. By the plating, the pseudo layer 60 with resistance to corrosion and excellent design can be formed. Alternatively, the pseudo layer 60 may be obtained by sintering a pattern formed on the second principal surface 10(2) by using screen printing with paste of silver, copper, or the like.

The pseudo layer 60 may be formed directly on the second principal surface 10(2) or may be formed indirectly. For example, the pseudo layer 60 may be formed on the second principal surface 10(2) side of the dielectric layer 10 with a resin layer interposed therebetween. For example, an intermediate film of polyvinyl butyral, ethylene-vinyl acetate, or the like, polyethylene terephthalate, or optically clear adhesive may be used as the resin layer.

A region where the pseudo layer 60 exists without overlapping the ground conductor layer 40 as the second conductor layer in a plan view is the first region. A region where the ground conductor layer 40 as the second conductor layer exists without overlapping the pseudo layer 60 is the second region. In the first embodiment, since the pseudo layer 60 and the ground conductor layer 40 do not overlap each other in a plan view, the first region is an optional region of the pseudo layer 60 and the second region is an optional region of the ground conductor layer 40.

### [Grayscale Difference Index F and Inconspicuousness]

In a case where patterns included in the first region and the second region are minute or in a case where the first region and the second region are viewed by a person from a distance, the first region and the second region appear in homogenized single colors to the human eye. This phenomenon is particularly significant in a case where the resolution of the human eye is lower than a resolution at which the patterns included in the first region and the second region can be recognized. The concentration of a color that appears to the human eye changes with the diameter of each pattern, the width of each line, or the pitch. For example, the color of a region appears darker as the diameter of each dot is larger, the width of each line is larger, or the pitch is smaller in the region. For example, the color of a region appears lighter as the diameter of each dot is smaller, the width of each line is smaller, or the pitch is larger in the region.

In the first embodiment, the above-described phenomenon is exploited to reduce the grayscale difference between the color of the first region when homogenized and the color of the second region when homogenized. Accordingly, the first region and the second region appear continuously integrated to the human eye, and thus the second region is inconspicuous.

### (Method of Calculating Grayscale Difference Index F)

In the first embodiment, a value F obtained by normalizing, with the number of gradations, the difference between the N-level gradation values (N is a natural number) of the first region and the second region in a case where the first region and the second region are read at a resolution of 400 dpi is used as the grayscale difference index. The value F is expressed by Expression (1) below.

$$F = \vert {n}_{1} - {n}_{2} \vert / N \qquad ( 1 )$$

In the expression, n₁ is the gradation value of the first region, and n₂ is the gradation value of the second region.

In this manner, the grayscale difference index F can be calculated by substituting the gradation value n₁ of the first region and the gradation value n₂ of the second region into Expression (1).

The above-described grayscale difference index F is preferably equal to or larger than 0 and equal to or smaller than 1.09×10⁻¹, more preferably equal to or larger than 0 and equal to or smaller than 6.25×10⁻², even more preferably equal to or larger than 0 and equal to or smaller than 3.52×10⁻², and particularly preferably equal to or larger than 0 and equal to or smaller than 1.56×10⁻². When the grayscale difference index F is equal to or larger than 0 and equal to or smaller than 1.09×10⁻¹, the grayscale difference is small, and accordingly, the second region is inconspicuous. When the grayscale difference index F is equal to or larger than 0 and equal to or smaller than 6.25×10⁻², the grayscale difference is further small, and accordingly, the second region is further inconspicuous. When the grayscale difference index F is equal to or larger than 0 and equal to or smaller than 3.52×10⁻², the grayscale difference is even further small, and accordingly, the second region is even further inconspicuous. When the grayscale difference index F is equal to or larger than 0 and equal to or smaller than 1.56×10⁻², the grayscale difference is so small that no boundary is noticeable, and accordingly, the second region is particularly inconspicuous. The grayscale difference index F is a value in a case where the resolution of an image capturing unit is 400 dpi.

Note that, in a case of N=256, |n₁−n₂| is preferably equal to or larger than 0 and equal to or smaller than 28, more preferably equal to or larger than 0 and equal to or smaller than 16, even more preferably equal to or larger than 0 and equal to or smaller than 9, and particularly preferably equal to or larger than 0 and equal to or smaller than 4.

(Method of Calculating Gradation Values n₁ and n₂)

The gradation value n₁ of the first region and the gradation value n₂ of the second region can be calculated from images obtained by homogenizing the patterns included in the first region and the second region.

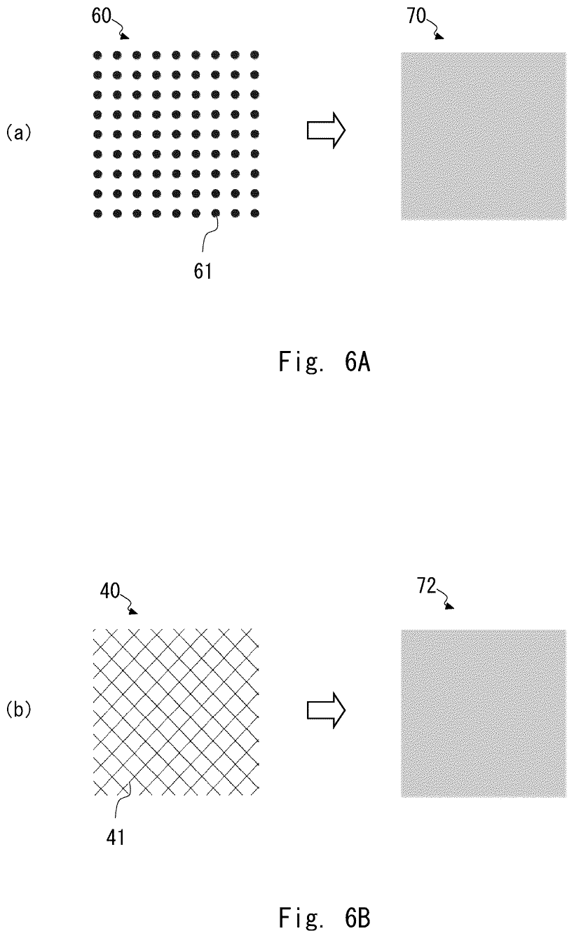

FIGS. 6A and 6B are diagrams for description of an example of homogenization processing according to the first embodiment. The left side in FIG. 6A illustrates a dot pattern of the first region included in the pseudo layer 60. First, an image of the dot pattern of the first region is captured by using an image capturing unit set to a predetermined resolution. The image capturing unit may be an image capturing unit included in an optical reading apparatus such as a digital camera or a scanner. When the resolution of the image capturing unit in this case is set to be equivalent to or lower than the resolution of the human eye, a captured image illustrated on the right side in FIG. 6A can be obtained. The resolution is relative resolution. The captured image includes a homogenized pattern 70 that is a homogenized image region. Then, the gradation value n₁ of the first region can be obtained by measuring the gradation value of the homogenized pattern 70. Measurement of the gradation value can be performed by optional image processing software. The gradation value n₁ may be the gradation value at one point in the homogenized pattern 70 or may be the average of the gradation values at a plurality of points in the homogenized pattern 70.

The resolution of the image capturing unit is preferably equal to or larger than 100 dpi and equal to or smaller than 500 dpi, more preferably equal to or larger than 200 dpi and equal to or smaller than 400 dpi, and even more preferably equal to or larger than 300 dpi and equal to or smaller than 400 dpi. When the resolution of the image capturing unit is equal to or larger than 100 dpi, pattern difference is reflected on the gradation value, and thus the reliability of the gradation value improves. When the resolution of the image capturing unit is equal to or larger than 200 dpi, difference in the gradation value is significant depending on the pattern, and thus the reliability of the gradation value further improves. When the resolution of the image capturing unit is equal to or larger than 300 dpi, a captured image equivalent to that seen by the human eye is obtained, and thus the gradation value in accordance with actual conditions can be calculated. When the resolution of the image capturing unit is equal to or smaller than 700 dpi, a captured image with small unevenness is obtained, and thus the gradation value can be calculated. When the resolution of the image capturing unit is equal to or smaller than 600 dpi, a captured image with smaller unevenness is obtained, and thus the accuracy of calculation of the gradation value improves. Note that the resolution of the human eye is known to be equal to or smaller than 300 dpi or 400 dpi.

The left side in FIG. 6B illustrates a mesh pattern of the second region included in the ground conductor layer 40. A homogenized pattern 72 can be obtained by performing homogenization processing on the mesh pattern of the second region like the dot pattern of the pseudo layer 60. Then, the gradation value n₂ of the second region can be obtained by measuring the gradation value of the homogenized pattern 72.

Note that, in another method of homogenization processing, the homogenized pattern 70 may be obtained by capturing an image of the dot pattern of the first region included in the pseudo layer 60 with the image capturing unit set to a predetermined resolution and performing image processing on the captured image obtained by the image capturing. Then, the gradation value n₁ of the first region can be obtained by measuring the gradation value of the homogenized pattern 70. Measurement of the gradation value can be performed by optional image processing software. The image capturing unit in this case may be an image capturing unit included in an optical reading instrument such as an optical microscope, a digital camera, or a scanner. The resolution of the image capturing unit in this case may be equal to or higher than a resolution at which the pattern can be recognized.

The gradation value n₂ of the second region may be the gradation value near the boundary with the first region and may be larger or smaller with separation from the first region.

### [Pattern Dimension and Gradation Value]

The dimension of a pattern is closely related to the gradation value when the pattern is observed.

For example, in a case where a grayscale value (N=256) is used as an example of the gradation value, the relation between (dot diameter/dot pitch) in the first region and the gradation value n₁ of the first region may be expressed by an expression below, where x₁ represents (dot diameter/dot pitch).

$${n}_{1} = - 261.4 {x}_{1} + 321.02 \qquad ( 2 )$$

For example, in a case where the grayscale value (N=256) is used as an example of the gradation value, the relation between (mesh line width/mesh pitch) in the second region and the gradation value n₂ of the second region may be expressed by an expression below, where x₂ represents (mesh line width/mesh pitch).

$${n}_{2} = - 8 61.64 {x}_{2} + 250.71 \qquad ( 3 )$$

### [Gradation Value and Antenna Performance]

In a case where the line width of the mesh of the second region is small or the pitch of the mesh is large, electric waves are easily transmitted through, and accordingly, antenna performance decreases. However, in a case where the line width of the mesh of the second region is large or the pitch of the mesh is small, electric waves are not easily transmitted through, and accordingly, antenna performance improves. Since (mesh line width/mesh pitch) x₂ is correlated with the gradation value n₂ of the second region as described above, antenna performance changes with the gradation value n₂ of the second region as well. Specifically, antenna performance decreases as the gradation value n₂ of the second region is larger, and antenna performance improves as the gradation value n₂ of the second region is smaller.

For example, in a case where the grayscale value (N=256) is used as an example of the gradation value, n₂ is preferably equal to or smaller than 246, more preferably equal to or smaller than 240, even more preferably equal to or smaller than 232, particularly preferably equal to or smaller than 217, and most preferably equal to or smaller than 211 to improve antenna performance. In a case where n₂ is equal to or smaller than 246, the line width of the mesh or the pitch of the mesh is a preferable size, and accordingly, electric waves are not easily transmitted through. For inconspicuousness of the second region, n₂ is preferably equal to or larger than 150, more preferably equal to or larger than 173, and even more preferably equal to or larger than 190.

Thus, the antenna unit 100 that is inconspicuous and has improved antenna performance can be provided by setting the gradation value n₂ of the second region in the above-described range and setting the grayscale difference index F in the above-described range.

A preferable range of (mesh line width/mesh pitch) x₂ can be derived from Expression (3) described above. The value x₂ is preferably equal to or larger than 5.47×10⁻³, more preferably equal to or larger than 1.24×10⁻², even more preferably equal to or larger than 2.17×10⁻², particularly preferably equal to or larger than 3.91×10⁻², and most preferably equal to or larger than 4.61×10⁻². The value x₂ is also preferably equal to or smaller than 1.17×10⁻¹, more preferably equal to or smaller than 9.02×10⁻², and even more preferably equal to or smaller than 7.05×10⁻². Thus, the antenna unit 100 that is inconspicuous and has improved antenna performance can be provided by setting (mesh line width/mesh pitch) x₂ in the preferable range and setting the grayscale difference index F in the above-described range.

The line width of the mesh may be equal to or larger than 5 μm and equal to or smaller than 30 μm or may be equal to or larger than 6 μm and equal to or smaller than 15 μm. The pitch-of-the-mesh may be equal to or larger than 50 μm and equal to or smaller than 500 μm or may be equal to or larger than 100 μm and equal to or smaller than 300 μm.

To set the grayscale difference index F in the above-described range, n₁ is preferably equal to or smaller than 246, more preferably equal to or smaller than 240, even more preferably equal to or smaller than 232, particularly preferably equal to or smaller than 217, and most preferably equal to or smaller than 211. The value n₁ is also preferably equal to or larger than 150, more preferably equal to or larger than 173, and even more preferably equal to or larger than 190.

A preferable range of (dot diameter/dot pitch) x₁ can be derived from Expression (2) described above. The value x₁ is preferably equal to or larger than 2.87×10⁻¹, more preferably equal to or larger than 3.10×10⁻¹, even more preferably equal to or larger than 3.41×10⁻¹, particularly preferably equal to or larger than 3.98×10⁻¹, and most preferably equal to or larger than 4.21×10⁻¹. The value x₁ is preferably equal to or smaller than 6.54×10⁻¹, more preferably equal to or smaller than 5.66×10⁻¹, and even more preferably equal to or smaller than 5.01×10⁻¹. Thus, the antenna unit 100 that is inconspicuous and has improved antenna performance can be provided by setting (dot diameter/dot pitch) x₁ in the preferable range and setting the grayscale difference index F in the above-described range.

The dot diameter may be equal to or larger than 50 μm and equal to or smaller than 500 μm.

In this manner, according to the first embodiment, the pseudo layer 60 is disposed around the ground conductor layer 40, and an antenna unit and a window glass with excellent design can be provided by adjusting the gradation value difference or color difference between the first region and the second region to a preferable range. Moreover, excellent antenna performance can be ensured by adjusting the gradation value of the second region or the dot dimension of the first region to a preferable range.

Note that the first embodiment may be modified as described below. For example, in the above-described first embodiment, the pattern included in the pseudo layer 60 is a pattern in which the conductor array elements 61 are arrayed separately from each other at a predetermined pitch but may be a pattern made of an insulator such as resin. In this case, the pattern may be a pattern in which circular insulators are arrayed separately from each other at a predetermined pitch or may be a continuous pattern in which insulator linear bodies are connected to each other, specifically, a mesh-like pattern. The shape of the pattern may be a rhombus, a triangle, a hexagon, a star, or any other shape.

The pseudo layer 60 may contain no conductor and be made of an insulator. In this case, the pseudo layer 60 may be a solid planar insulator without a pattern.

Examples of the material of the insulator include acrylic, polycarbonate, polyvinyl butyral (PVB), cycloolefin polymer (COP), polyethylene terephthalate (PET), polyimide, ceramics, or sapphire; silicone resin, polysulfide resin, acrylic resin, and other resins; and glass. The pseudo layer 60 may be made of these materials on which ink (pigment) is printed.

In the first embodiment, the ground conductor layer 40 includes a mesh-like pattern, but the ground conductor layer 40 may be a solid planar conductor. In this case, the material of the conductor used for the ground conductor layer 40 may be a transparent material such as indium tin oxide (ITO).

### Second Embodiment

A second embodiment of the present invention will be described below. In the first embodiment, the pseudo layer 60 is positioned on the same plane as the ground conductor layer 40 of the antenna unit 100. In the second embodiment, the pseudo layer 60 is positioned on a plane different from that of the ground conductor layer 40.

### Configuration Example 1

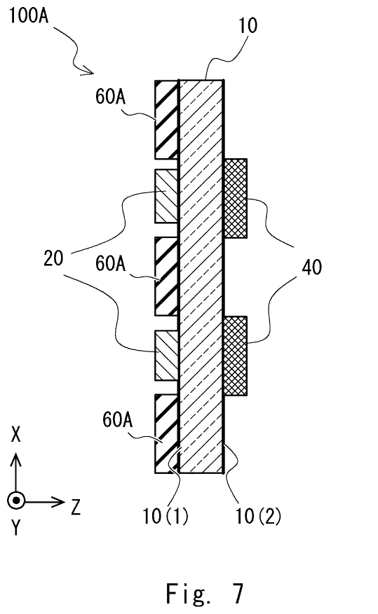

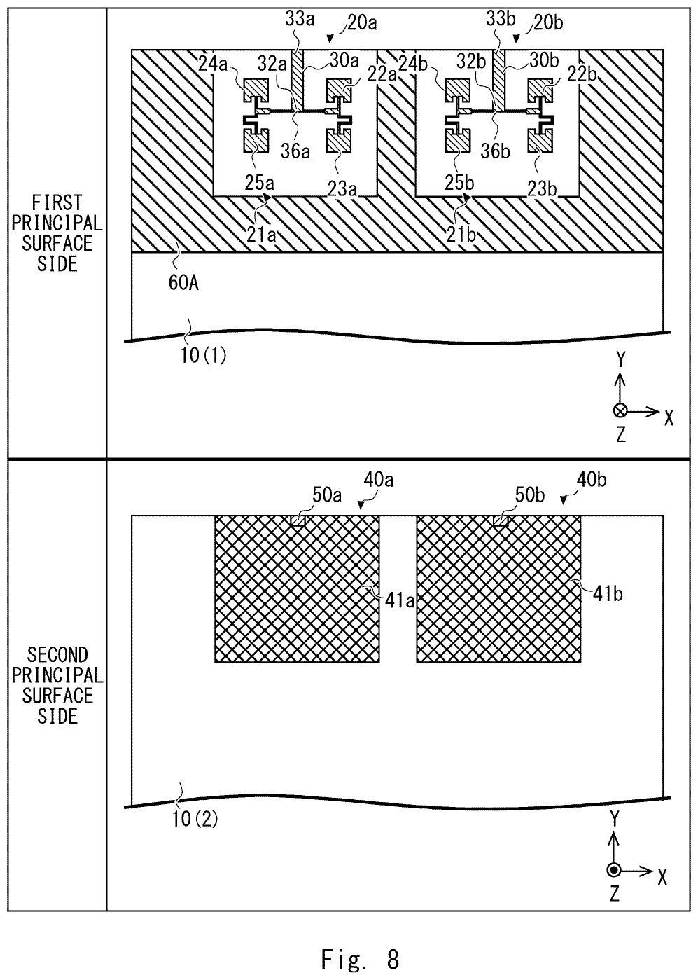

FIG. 7 is a top drawing of an antenna unit 100A according to Configuration Example 1 of the second embodiment. FIG. 8 is a diagram illustrating the radiation element layer 20, the ground conductor layer 40, and a pseudo layer 60A formed in the dielectric layer 10 of the antenna unit 100A according to the second embodiment in a plan view.

The antenna unit 100A includes the dielectric layer 10, the radiation element layer 20, the pseudo layer 60A, and the ground conductor layer 40 as examples of the dielectric layer, the first conductor layer, the pseudo layer, and the second conductor layer described above in the overview, respectively.

In Configuration Example 1, the radiation element layer 20 is provided on the first principal surface 10(1) side of the dielectric layer 10 with respect to the dielectric layer 10.

In Configuration Example 1, the ground conductor layer 40 is a camouflage target layer as in the first embodiment. The ground conductor layer 40 is provided on the second principal surface 10(2) side of the dielectric layer 10 with respect to the dielectric layer 10.

In Configuration Example 1, the pseudo layer 60A is a camouflage layer for inconspicuousness of the ground conductor layer 40 as the second conductor layer as in the first embodiment. Thus, similarly to the pseudo layer 60, the pseudo layer 60A is disposed around the ground conductor layer 40 in a plan view. However, the pseudo layer 60A is provided on the first principal surface 10(1) side of the dielectric layer 10 with respect to the dielectric layer 10, which is difference from the pseudo layer 60. More specifically, the pseudo layer 60A is formed on the same plane as the radiation element layer 20.

Note that, in Configuration Example 1, the first region is an optional region of the pseudo layer 60A, and the second region is an optional region of the ground conductor layer 40. For example, preferable ranges of F, x₂, n₂, and D are the same as in the first embodiment.

In Configuration Example 1, the pseudo layer 60A is disposed around the ground conductor layer 40 in a plan view although the pseudo layer 60A is not on the same plane as the ground conductor layer 40, and the gradation value difference or color difference between the first region and the second region is adjusted to a preferable range, and accordingly, the same effects as in the first embodiment are achieved.

### Configuration Example 2

In Configuration Example 2, the pseudo layer 60A is a camouflage layer for inconspicuousness of the radiation element layer 20 instead of inconspicuousness of the ground conductor layer 40. For example, the radiation element layer 20 is conspicuous in a case where the conductor used for the ground conductor layer 40 is a transparent material such as ITO and the conductor used for the radiation element layer 20 is an opaque material such as gold, silver, or copper. However, this can be avoided as the pseudo layer 60A camouflages the radiation element layer 20.

In Configuration Example 2, disposition of the radiation element layer 20, the ground conductor layer 40, and the pseudo layer 60A in the Z-axis direction is the same as in Configuration Example 1 of the second embodiment. In other words, the radiation element layer 20 is formed on the first principal surface 10(1) with respect to the dielectric layer 10, and the ground conductor layer 40 is formed on the second principal surface 10(2) with respect to the dielectric layer 10. However, in the antenna unit 100A in Configuration Example 2, the radiation element layer 20 is the second conductor layer described above in the overview and the ground conductor layer 40 is the first conductor layer described above in the overview, which is difference from Configuration Example 1.

In Configuration Example 2, the ground conductor layer 40 may include a continuous pattern, specifically, a mesh-like pattern like the ground conductor layer 40 of the first embodiment, or may be a solid planar conductor.

In Configuration Example 2, the radiation element layer 20 may include a continuous pattern, specifically, a mesh-like pattern like the ground conductor layer 40 of the first embodiment.

In Configuration Example 2, the pseudo layer 60A is formed on the same plane as the radiation element layer 20.

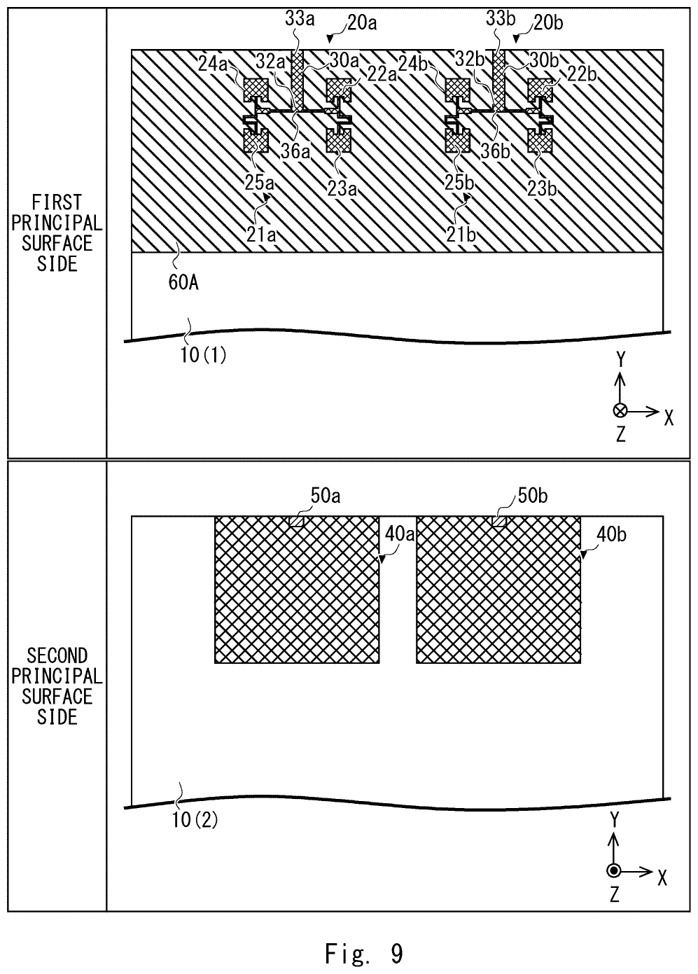

FIG. 9 is a diagram illustrating the radiation element layer 20, the ground conductor layer 40, and the pseudo layer 60A formed in the dielectric layer 10 of the antenna unit 100A according to Configuration Example 2 of the second embodiment in a plan view. The pseudo layer 60A is disposed around the radiation element layer 20 in a plan view. Specifically, the pseudo layer 60A is disposed in contact with at least part of the outer edge of the radiative conductor 21a and the outer edge of a power supply line 30 included in the radiation element layer 20.

Note that, in Configuration Example 2, the first region is an optional region of the pseudo layer 60A, and the second region is an optional region of the radiation element layer 20. For example, preferable ranges of F, x₂, n₂, and D are the same as in the first embodiment.

The pseudo layer 60A is disposed around the radiation element layer 20 in a plan view even when the radiation element layer 20 is a camouflage target, and the gradation value difference or color difference between the first region and the second region is adjusted to a preferable range so that the radiation element layer 20 can be excellently camouflaged. Accordingly, design can be improved.

### Configuration Example 3

From a viewpoint of manufacturing cost, the pseudo layer is preferably formed on the same plane as the ground conductor layer 40 as in the first embodiment or the pseudo layer is preferably formed on the same plane as the radiation element layer 20 as in the second embodiment. Moreover, from a viewpoint of parallax, the pseudo layer is preferably formed on the same plane as the second conductor layer as a camouflage target. However, the pseudo layer may be formed on a plane different from any of the radiation element layer 20 and the ground conductor layer 40.

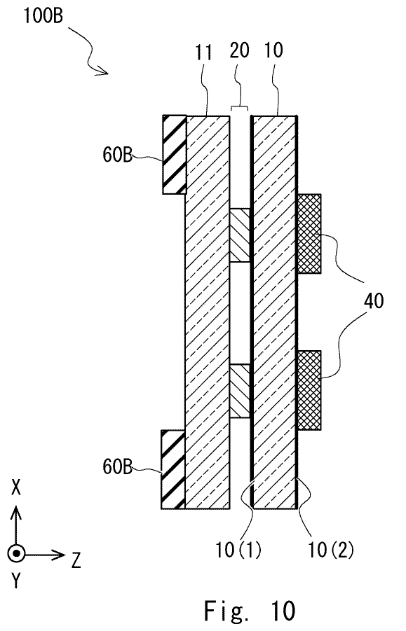

For example, an antenna unit 100B has the same configuration as Configuration Example 1 or Configuration Example 2 in a plan view but has a different configuration in a top view. FIG. 10 is a top drawing of the antenna unit 100B according to Configuration Example 3 of the second embodiment. The antenna unit 1001B includes a dielectric layer 11 and a pseudo layer 60B in place of the pseudo layer 60A, which is difference from the antenna unit 100A. Note that the antenna unit 100B includes the dielectric layer 10 in addition to the dielectric layer 11, and the dielectric layer described above in the overview is the dielectric layer 10. In the antenna unit 100B, the second conductor layer described above in the overview may be the ground conductor layer 40 or may be the radiation element layer 20.

The dielectric layer 11 is a transparent plate, sheet, or film member through which visible light transmits. The dielectric layer 11 functions as a support substrate of the pseudo layer 60B. The dielectric layer 11 is provided in parallel to the XY plane on the negative Z-axis direction side with respect to the radiation element layer 20. For example, the dielectric layer 11 is disposed in contact with the radiation element layer 20. The other description of the dielectric layer 11 is the same as that of the dielectric layer 10 and thus omitted.

The pseudo layer 60B is provided on the negative Z-axis direction side with respect to the dielectric layer 11. For example, the pseudo layer 60B is disposed on a surface of the dielectric layer 11 such that surfaces thereof are parallel to the XY plane. The shape and position of the pseudo layer 60B in a plan view may be the same as those of the pseudo layer 60A in Configuration Example 1 or Configuration Example 2.

Note that, in Configuration Example 3, the first region is an optional region of the pseudo layer 60B, and the second region is an optional region of the radiation element layer 20 or the ground conductor layer 40. For example, preferable ranges of F, x₂, n₂, and D are the same as in the first embodiment.

Note that the dielectric layer 11 may be provided on the positive Z-axis direction side with respect to the ground conductor layer 40.

In this case, the pseudo layer 60B is provided on the positive Z-axis direction side with respect to the dielectric layer 11.

The pseudo layer 60B is disposed around the second conductor layer as a camouflage target in a plan view, and the gradation value difference or color difference between the first region and the second region is adjusted to a preferable range, and accordingly, the same effects as in Configuration Example 1 or Configuration Example 2 are achieved.

### Third Embodiment

A third embodiment of the present invention will be described below. There is a problem that the FB ratio of the antenna unit decreases because radiation to the indoor side is large due to reflection of electric waves at an interface of the window glass body 200. The indoor side is the positive Z-axis direction side. An antenna unit in which a waveguide layer is provided on the outdoor side of a radiation element layer to solve this problem is known. An antenna unit according to the third embodiment corresponds to such an antenna unit. In the third embodiment, a camouflage target is the waveguide layer in addition to a ground conductor layer.

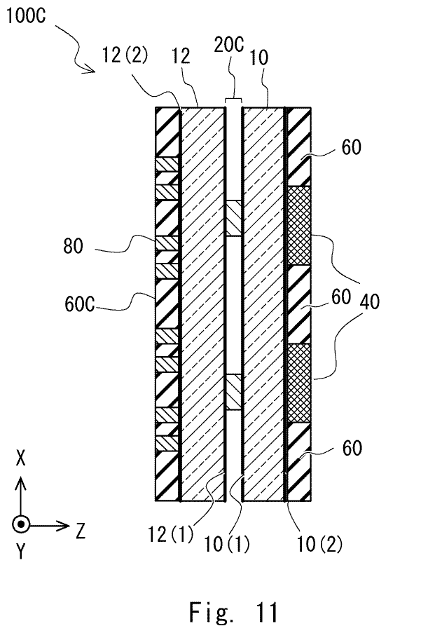

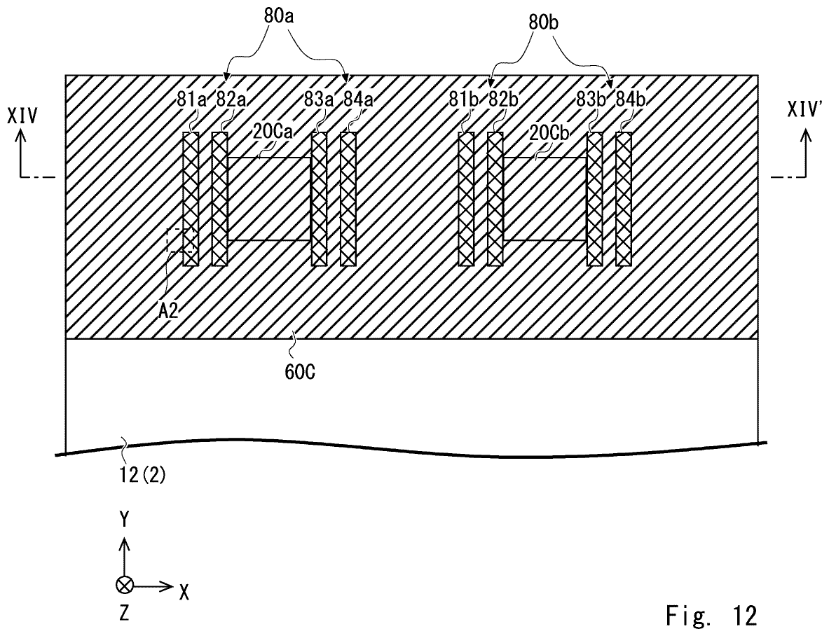

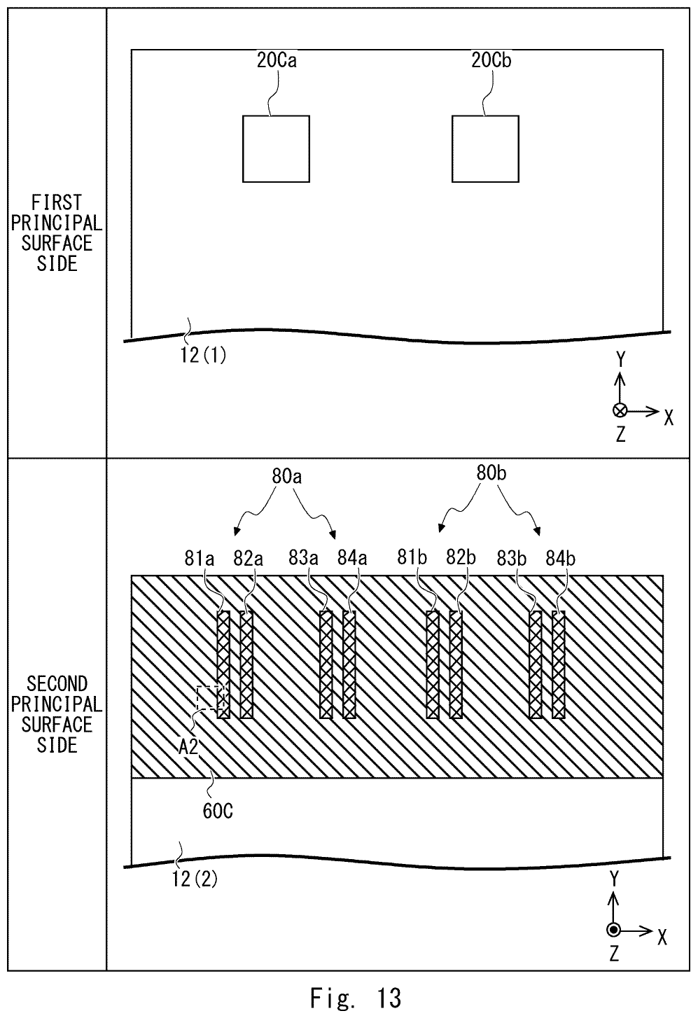

FIG. 11 is a cross-sectional view of an antenna unit 100C according to the third embodiment. Specifically, FIG. 11 is an XIV-XIV′ cross-sectional view of the antenna unit 100C illustrated in FIG. 12. FIG. 12 is a plan drawing of the antenna unit 100C according to the third embodiment. FIG. 13 is a diagram illustrating a radiation element layer 20C, a waveguide layer 80, and a pseudo layer 60C formed in a dielectric layer 12 according to the third embodiment in a plan view. FIG. 13 illustrates a plan drawing of the dielectric layer 12 when viewed from the first principal surface side and a plan drawing of the dielectric layer 12 when viewed from the second principal surface side.

In the antenna unit 100C, the dielectric layer, the first conductor layer, the pseudo layer, and the second conductor layer described above in the overview are the dielectric layer 12, the radiation element layer 20C, the pseudo layer 60C, and the waveguide layer 80.

FIGS. 12 and 13 illustrate, as an example, a configuration (refer to “first principal surface side” in FIG. 13) in which two antenna elements 20Ca and 20Cb are formed in the radiation element layer 20 illustrated in FIG. 11. FIGS. 12 and 13 also illustrate a configuration (refer to “second principal surface side” in FIG. 13) in which two waveguide parts 80a and 80b are formed in the waveguide layer 80 illustrated in FIG. 11. The two ground conductors 40a and 40b are formed in the ground conductor layer 40. Note that the numbers of radiation elements, ground conductor layers, and waveguide parts included in the antenna unit 100C are not limited to two but may be one or may be equal to or larger than three.

### (Dielectric Layer 12)

As illustrated in FIG. 11, the dielectric layer 12 is a transparent plate, sheet, or film member through which visible light transmits. The dielectric layer 12 functions as a spacer for preventing the radiation element layer 20C and the waveguide layer 80 from contacting each other. The dielectric layer 12 has principal surfaces parallel to the XY plane and has a thickness direction parallel to the Z-axis direction. The other description of the dielectric layer 12 is the same as that of the dielectric layer 10 and thus omitted.

In the following description, the principal surface of the dielectric layer 12 on the positive Z-axis direction side is referred to as a first principal surface 12(1), and the principal surface of the dielectric layer 12 in the negative Z-axis direction is referred to as a second principal surface 12(2). Accordingly, the second principal surface 12(2) is a principal surface opposite to the first principal surface 12(1).

### (Radiation Element Layer 20C)

The radiation element layer 20C is a layer including a radiative conductor 21C formed to be able to transmit and receive electric waves in a target frequency band. Similarly to the radiation element layer 20, the radiation element layer 20C is provided on the first principal surface 10(1) side of the dielectric layer 10 with respect to the dielectric layer 10. Specifically, the radiation element layer 20C is formed on at least a partial region of the first principal surface 10(1) of the dielectric layer 10 such that surfaces thereof are parallel to the XY plane.

In the third embodiment, the radiation element layer 20 is provided on the first principal surface 12(1) side of the dielectric layer 12 with respect to the dielectric layer 12. Specifically, the radiation element layer 20C contacts at least a partial surface of the first principal surface 12(1) of the dielectric layer 12 at an edge face in the negative Z-axis direction.

As illustrated in FIGS. 12 and 13, the antenna elements 20Ca and 20Cb have basically the same configurations and functions as the antenna elements 20a and 20b, but the antenna elements 20Ca and 20Cb are rectangular planar conductors. Note that the shapes of the antenna elements 20Ca and 20Cb are not limited to rectangles but may be circular shapes or any other optional shapes.

### (Waveguide Layer 80)

As illustrated in FIG. 11, the waveguide layer 80 has a function to guide electric waves radiated by the radiation element layer 20C in a predetermined direction. Specifically, the waveguide layer 80 has a function to guide, to the outdoor side, electric waves radiated by the radiation element layer 20C toward the window glass body 200. Accordingly, the FB ratio improves.

The waveguide layer 80 is provided on the outdoor side with respect to the dielectric layer 12, in other words, on the second principal surface 12(2) side of the dielectric layer 12. Specifically, the waveguide layer 80 is formed on at least a partial region of the second principal surface 12(2) of the dielectric layer 12 such that surfaces thereof are parallel to the XY plane.

The material of a conductor used for the waveguide layer 80 is, for example, gold, silver, copper, platinum, aluminum, or chromium. The waveguide layer 80 may be a film formed by plating with the above-described material. By the plating, the waveguide layer 80 with resistance to corrosion and excellent design can be formed. Alternatively, the waveguide layer 80 may be obtained by sintering a pattern formed on the second principal surface 12(2) by using screen printing with paste of silver, copper, or the like.

The waveguide layer 80 may be formed directly on the second principal surface 12(2) or may be formed indirectly. For example, the waveguide layer 80 may be formed on the second principal surface 12(2) of the dielectric layer 12 with a resin layer interposed therebetween. For example, an intermediate film of polyvinyl butyral, ethylene-vinyl acetate, or the like, polyethylene terephthalate, or OCA may be used as the resin layer.

As illustrated in FIGS. 12 and 13, the waveguide part 80a included in the waveguide layer 80 includes conductor elements 81a, 82a, 83a, and 84a. The conductor elements 81a, 82a, 83a, and 84a are strip-shaped conductor elements disposed in parallel to and separately from one another. In the present example, the conductor elements 81a, 82a, 83a, and 84a extend in the Y-axis direction. In the present example, the conductor elements 81a, 82a, 83a, and 84a are arranged in order from the negative X-axis direction and separated from each other by a predetermined distance in the X-axis direction. In a plan view, the distance between the conductor element 82a and the conductor element 83a is longer than the distance between the conductor element 81a and the conductor element 82a and the distance between the conductor element 83a and the conductor element 84a. The antenna element 20Ca is disposed between the conductor element 82a and the conductor element 83a in a plan view.

Similarly to the linear ground conductor 41 of the ground conductor layer 40, each of the conductor elements 81a, 82a, 83a, and 84a may be made of a conductor pattern formed to have gaps in a plan view.

Accordingly, each of the conductor elements 81a, 82a, 83a, and 84a is made of a continuous pattern in which linear conductors are electrically connected to each other, specifically, a mesh-like conductor pattern.

Note that the waveguide part 80b has the same configuration as the waveguide part 80a, and thus description thereof is omitted.

### (Pseudo Layer 60C)

As illustrated in FIG. 11, the pseudo layer 60C is a camouflage layer for inconspicuousness of the waveguide layer 80 as the second conductor layer in the third embodiment. Similarly to the waveguide layer 80, the pseudo layer 60C is provided on the second principal surface 12(2) side of the dielectric layer 12 with respect to the dielectric layer 12. More specifically, the pseudo layer 60C is formed on the same plane as the waveguide layer 80. In other words, the waveguide layer 80 is formed on at least a partial region of the second principal surface 10(2) of the dielectric layer 10 such that surfaces thereof are parallel to the XY plane.

As illustrated in FIGS. 12 and 13, the pseudo layer 60C is disposed around the waveguide layer 80 in a plan view. For example, the pseudo layer 60C may be disposed around the entire circumference of the conductor elements 81a to 84a or may be disposed in contact with part thereof. The pseudo layer 60C may be not disposed between the conductor element 81a and the conductor element 82a adjacent to each other and between the conductor element 83a and the conductor element 84a adjacent to each other.

An edge portion of the pseudo layer 60C in the X-axis direction may coincide with an edge portion of the dielectric layer 12 in the X-axis direction, but may be separated by a predetermined distance from the edge portion of the dielectric layer 12 in the X-axis direction. This is the same for edge portions in the Y-axis direction.

In this manner, the waveguide layer 80 can be camouflaged when the pseudo layer 60C is disposed around the waveguide layer 80 in a plan view. Accordingly, design can be improved. Particularly significant effects are achieved in a case where the antenna unit 100C includes the plurality of waveguide parts 80a and 80b separated from each other.

A region A2 illustrated in FIGS. 12 and 13 is a region including the boundary of the pseudo layer 60C and the waveguide layer 80. The description of the region A1 with the pseudo layer 60, the ground conductor layer 40, the first principal surface 10(1), and the second principal surface 10(2) replaced with the pseudo layer 60C, the waveguide layer 80, the first principal surface 12(1), and the second principal surface 12(2), respectively, is applicable to the region A2, and thus description of the region A2 is omitted. In other words, in the third embodiment, the first region is an optional region of the pseudo layer 60C, the second region is an optional region of the waveguide layer 80, and for example, specific configurations of patterns of the waveguide layer 80 and the pseudo layer 60C and preferable ranges of F, x₂, n₂, and D are the same as in the first embodiment.

Note that the antenna unit 100C further includes the ground conductor layer 40 provided on a side opposite to the dielectric layer 12 with respect to the radiation element layer 20C with the dielectric layer 10 interposed therebetween, and the pseudo layer 60 that camouflages the ground conductor layer 40. The configurations of the dielectric layer 10, the ground conductor layer 40, and the pseudo layer 60 are the same as in the first embodiment. The radiation element layer 20C is supplied with power from a power supply point (not illustrated) corresponding to a ground electrode (not illustrated) of the ground conductor layer 40.

In this manner, according to the third embodiment, the pseudo layer 60C is provided around the waveguide layer 80 in a plan view and the gradation value difference or color difference between the first region and the second region is adjusted to a preferable range so that the waveguide layer 80 is inconspicuous in a preferable manner. Accordingly, an antenna unit and a window glass with excellent design can be provided.

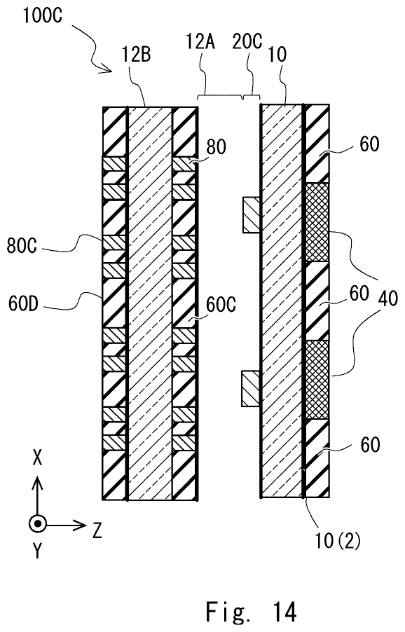

Note that the dielectric layer 12 between the waveguide layer 80 and the radiation element layer 20C may be a space instead of a transparent member. The medium of the space may be air or other gas but the space may be vacuum. FIG. 14 illustrates an example of a case where a space 12A is provided in place of the dielectric layer 12. In this case, as illustrated in FIG. 14, the antenna unit 100C may include a dielectric layer 12B supporting the waveguide layer 80 on the negative Z-axis direction side with respect to the waveguide layer 80. Since the space 12A exists between the waveguide layer 80 and the radiation element layer 20C, resonance frequency is unlikely to be affected by a transparent member and the FB ratio improves. In a case where the space 12A is provided in place of the dielectric layer 12 and the dielectric layer 12B supporting the waveguide layer 80 is provided on the negative Z-axis direction side with respect to the waveguide layer 80, a waveguide layer 80C may be additionally provided on the negative Z-axis direction side of the dielectric layer 12B as illustrated in FIG. 14. In this case, a pseudo layer 60D that camouflages the waveguide layer 80C may be additionally provided.

### Fourth Embodiment

A fourth embodiment of the present invention will be described below. In the third embodiment, the pseudo layer 60C is positioned on the same plane as the waveguide layer 80 of the antenna unit 100C. However, the pseudo layer 60C may be positioned on a plane different from the waveguide layer 80. Note that, in the fourth embodiment as well, the dielectric layer, the first conductor layer, the pseudo layer, and the second conductor layer described above in the overview are the dielectric layer 12, the radiation element layer 20C, the pseudo layer 60C, and the waveguide layer 80 as in the third embodiment.

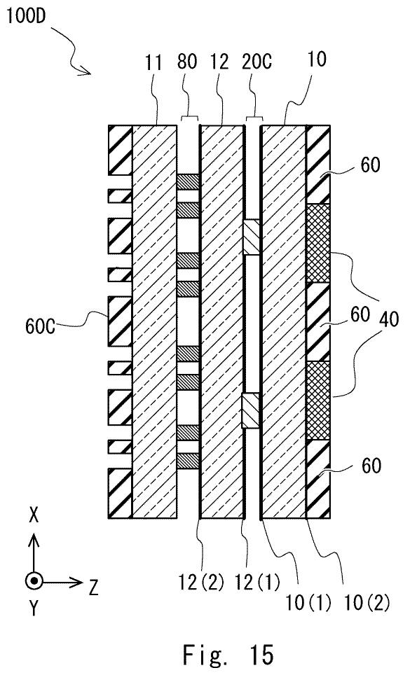

FIG. 15 is a top drawing of an antenna unit 100D according to the fourth embodiment. In the antenna unit 100D, the pseudo layer 60C is formed on a plane different from the radiation element layer 20 and the waveguide layer 80. For example, the antenna unit 100D further includes the dielectric layer 11 functioning as a support substrate of the pseudo layer 60C. The dielectric layer 11 is provided in parallel to the XY plane on the negative Z-axis direction side with respect to the waveguide layer 80. For example, the dielectric layer 11 is disposed in contact with the waveguide layer 80. The other description of the dielectric layer 11 is the same as that of the dielectric layer 11 in Configuration Example 3 of the second embodiment.

The pseudo layer 60C is provided on the negative Z-axis direction side with respect to the dielectric layer 11. For example, the pseudo layer 60C is disposed on a surface of the dielectric layer 11 such that surfaces thereof are parallel to the XY plane. The shape and position of the pseudo layer 60C in a plan view may be the same as those of the pseudo layer 60C in the third embodiment.

Note that, in the fourth embodiment the first region is an optional region of the pseudo layer 60C, and the second region is an optional region of the waveguide layer 80. For example, preferable ranges of F, x₂, n₂, and D are the same as in the first embodiment.

The pseudo layer 60C is disposed around the waveguide layer 80 in a plan view even when positioned on a plane different from the waveguide layer 80, and the gradation value difference or color difference between the first region and the second region is adjusted to a preferable range, and accordingly, the same effects as in the third embodiment are achieved.

### Fifth Embodiment

A fifth embodiment of the present invention will be described below. The fifth embodiment is a modification of the first embodiment. In the antenna unit 100 according to in the first embodiment, the radiation element layer 20 and the ground conductor layer 40 are formed facing each other through the dielectric layer 10. In an antenna unit according to the fifth embodiment, the radiation element layer and the ground conductor layer are formed on the same principal surface side with respect to the dielectric layer 10.

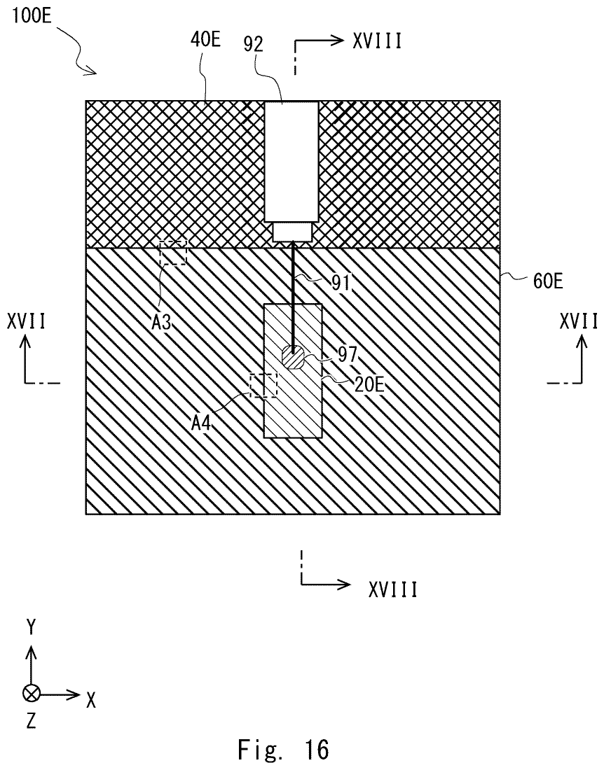

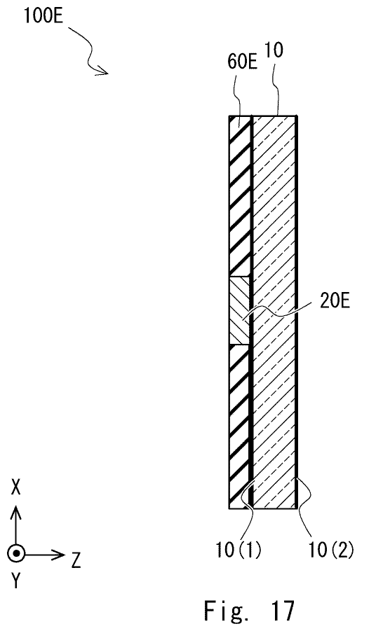

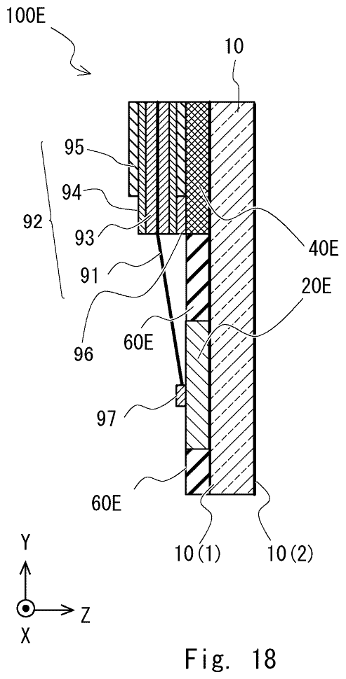

FIG. 16 is a plan drawing of an antenna unit 100E according to the fifth embodiment. FIG. 17 is a cross-sectional view of the antenna unit 100E according to the fifth embodiment. Specifically, FIG. 17 is a cross-sectional view of the antenna unit 100E in FIG. 16 taken along line XVII-XVII. FIG. 18 is a cross-sectional view of the antenna unit 100E according to the fifth embodiment. Specifically, FIG. 18 is a cross-sectional view of the antenna unit 100E in FIG. 16 taken along line XVIII-XVIII.

In the fifth embodiment, the dielectric layer, the first conductor layer, the pseudo layer, and the second conductor layer described above in the overview are the dielectric layer 10, a radiation element layer 20E, a ground conductor layer 40E, and a pseudo layer 60E.

The radiation element layer 20E, the ground conductor layer 40E, and the pseudo layer 60E have basically the same configurations and functions as the radiation element layer 20, the ground conductor layer 40, and the pseudo layer 60 but are different in shape and disposition. As illustrated in FIGS. 17 and 18, the radiation element layer 20E, the ground conductor layer 40E, and the pseudo layer 60E are each provided on the first principal surface 10(1) side of the dielectric layer 10 with respect to the dielectric layer 10.

Specifically, as illustrated in FIG. 17, the radiation element layer 20E and the pseudo layer 60E are formed on at least part of the first principal surface 10(1) of the dielectric layer 10 such that surfaces thereof are parallel to the XY plane. As illustrated in FIG. 18, the ground conductor layer 40E is formed on at least part of the first principal surface 10(1) of the dielectric layer 10 such that surfaces thereof are parallel to the XY plane.

A cable 92 illustrated in FIG. 18 and the like is a member electrically connecting the radiation element layer 20E and the ground conductor layer 40E and includes a conductive wire 91, an insulator 93, an external conductor 94, and a sheath 95. In the cable 92, the insulator 93 covers the conductive wire 91, the external conductor 94 covers the insulator 93, and the sheath 95 covers the external conductor 94. As illustrated in FIG. 18, the cable 92 is disposed to bridge the radiation element layer 20E and the ground conductor layer 40E. Note that the external conductor 94 included in the cable 92 is exposed at a place adjacent to the ground conductor layer 40E and electrically connected to the ground conductor layer 40E by contacting or soldering. In the example illustrated in FIG. 18, the external conductor 94 is electrically connected to the ground conductor layer 40E by solder 96. The conductive wire 91 included in the cable 92 is exposed at a place adjacent to the radiation element layer 20E and electrically connected to the radiation element layer 20E by contacting or soldering. In the example illustrated in FIG. 18, the conductive wire 91 is electrically connected to the radiation element layer 20E by solder 97.

As illustrated in FIG. 16, the radiation element layer 20E is a rectangular planar conductor. Note that the shape of the radiation element layer 20E is not limited thereto but may be a circular shape or any other optional shape. The radiation element layer 20E is disposed at a part on the negative Y-axis direction side of the center of the first principal surface 10(1) of the dielectric layer 10. The radiation element layer 20E includes a mesh-like conductor pattern.

The ground conductor layer 40E is a planar conductor pattern. The ground conductor layer 40E is disposed at a part on the positive Y-axis direction side of the center of the first principal surface 10(1) without overlapping the radiation element layer 20E in a plan view. In the present example, an edge portion of the ground conductor layer 40E in the positive Y-axis direction coincides with an edge portion of the first principal surface 10(1) of the dielectric layer 10 in the positive Y-axis direction but may be separated from the edge portion of the first principal surface 10(1) in the positive Y-axis direction by a predetermined distance in the negative Y-axis direction.

Note that the conductor pattern of the ground conductor layer 40E is the same as the ground conductor layer 40, and thus description thereof is omitted.

The pseudo layer 60E is an example of the above-described pseudo layer. The pseudo layer 60E is a camouflage layer for inconspicuousness of the radiation element layer 20E as the first conductor layer and the ground conductor layer 40E as the second conductor layer. The pseudo layer 60E is a planar layer. The pseudo layer 60E is disposed around the ground conductor layer 40 and the radiation element layer 20E in a plan view. Accordingly, the radiation element layer 20E and the ground conductor layer 40E, which would be conspicuous when separately disposed, are inconspicuous.

A region A3 illustrated in FIG. 16 is a region including the boundary of the pseudo layer 60E and the ground conductor layer 40E. A region A4 illustrated in FIG. 16 is a region including the boundary of the pseudo layer 60E and the radiation element layer 20E. The description of the region A1 with the pseudo layer 60 and the ground conductor layer 40 replaced with the pseudo layer 60E and the ground conductor layer 40E, respectively, is applicable to the region A3, and thus description thereof is omitted. The description of the region A1 with the pseudo layer 60 and the ground conductor layer 40 replaced with the pseudo layer 60E and the radiation element layer 20E, respectively, is applicable to the region A4, and thus description thereof is omitted. For example, specific configurations of patterns of the waveguide layer 80 and the pseudo layer 60C and preferable ranges of F, x₂, n₂, and D are the same as in the first embodiment.

In this manner, according to the fifth embodiment, an antenna unit and a window glass with excellent design can be provided even in a case where the ground conductor layer and the radiation element layer are formed on the same principal surface side.

Note that the pseudo layer 60E may be a camouflage layer for inconspicuousness of any one of the radiation element layer 20E as the first conductor layer and the ground conductor layer 40E as the second conductor layer. In this case, the pseudo layer 60E is disposed around a camouflage target layer in a plan view.

### EXAMPLES

### Experiment Example 1: Grayscale Difference Index F and Inconspicuousness

The inventors performed Experiment Example 1 described below to verify influence of the grayscale difference index F between the first region and the second region described above on inconspicuousness of the second region. Examples 1 to 10 are examples, and examples 11 to 13 are comparative examples. In Experiment Example 1 below, the gradation value is, as an example, the gradation value of a grayscale having a gradation number N of 256.

### (Specimen)

A sheet with a mesh pattern (mesh-like pattern) of 500 mm in height, 600 mm in width, and 0.14 mm in thickness was used as a specimen corresponding to the first region. The mesh openings of a specimen of Examples 1 to 6, 11, and 12 were regular hexagonal, the distance between the centers of adjacent regular hexagons was 274 μm, and the line width of each mesh opening was 14 μm. The mesh openings of a specimen of Examples 7 to 10 and 13 were regular hexagonal, the distance between the centers of adjacent regular hexagons was 548 μm, and the line width of each mesh opening was 14 μm. In addition, a sheet including a dot pattern with a diameter of 70 μm to 120 μm and a pitch of 150 μm to 280 μm was used as a specimen corresponding to the second region. Note that dots were substantially circular. In each example, the specimen corresponding to the first region was selected from among a plurality of specimens with different mesh patterns, and the specimen corresponding to the second region was selected from among a plurality of specimens with different dot patterns.

### (Measurement of Gradation Value)

First, an image of each specimen was captured by using iR-ADV C5235F manufactured by Canon Inc. as an optical reading apparatus to acquire a captured image. The reading resolution in this case was 400 dpi. Subsequently, the gradation value was measured at three places selected at random in the captured image by using Microsoft Paint of Microsoft Corporation. Then, the average of the gradation value over the three places selected at random was calculated as the gradation value n₁ of the first region or the gradation value n₂ of the second region corresponding to the specimen.

### (Calculation of Grayscale Difference Index F)

The grayscale difference index F was calculated by substituting the gradation value n₁ of the first region and the gradation value n₂ of the second region into Expression (1) described above.

### (Evaluation of Inconspicuousness)

In each example, the specimen corresponding to the first region and the specimen corresponding to the second region were arranged side by side, and inconspicuousness of the specimen corresponding to the second region was visually evaluated. The inconspicuousness evaluation is sensory evaluation. The inconspicuousness evaluation was performed by a plurality of examinees. Then, in each experiment example, a ratio r of examinees who evaluated that the specimen corresponding to the second region was inconspicuous among all examinees was calculated. Results are listed in Table 1.

### <<Evaluation Criteria of Inconspicuousness>>

Excellent: r is equal to or larger than 50%.

Good: r is larger than 0% and smaller than 50%.

Poor: r is 0%.

TABLE 1

| Example | n₁ | n₂ | \| n₁ − n₂\| | F | r [%] | Evaluation |
|---|---|---|---|---|---|---|
| 1 | 201 | 173 | 28 | 1.09 × 10⁻¹ | 2.70 | Good |
| 2 | 201 | 217 | 16 | 6.25 × 10⁻² | 5.41 | Good |
| 3 | 201 | 188 | 13 | 5.08 × 10⁻² | 29.73 | Good |
| 4 | 201 | 192 | 9 | 3.52 × 10⁻² | 67.57 | Excellent |
| 5 | 201 | 197 | 4 | 1.56 × 10⁻² | 70.27 | Excellent |
| 6 | 201 | 202 | 1 | 3.91 × 10⁻³ | 58.11 | Excellent |
| 7 | 232 | 220 | 12 | 4.69 × 10⁻² | 32.43 | Good |
| 8 | 232 | 240 | 8 | 3.13 × 10⁻² | 13.51 | Good |
| 9 | 232 | 236 | 4 | 1.56 × 10⁻² | 81.08 | Excellent |
| 10 | 232 | 231 | 1 | 3.91 × 10⁻² | 72.97 | Excellent |
| 11 | 201 | 168 | 33 | 1.29 × 10⁻¹ | 0 | Poor |
| 12 | 201 | 231 | 30 | 1.17 × 10⁻¹ | 0 | Poor |
| 13 | 232 | 217 | 15 | 5.86 × 10⁻² | 0 | Poor |

In Examples 1 to 6, the gradation value n₁ of the first region was 201, |n₁−n₂| was equal to or smaller than 28, and F was equal to or smaller than 1.09×10⁻¹. In Examples 1 to 6, r was equal to or larger than 2.70%, and inconspicuousness was good or excellent. In Examples 4 to 6, in particular, |n₁−n₂| was equal to or smaller than 9, F was equal to or smaller than 3.52×10⁻², r was equal to or larger than 58.11%, and inconspicuousness was excellent.

In Examples 11 and 12, the gradation value n₁ of the first region was 201, but |n₁−n₂| was 30 and 33, respectively, and F was 1.29×10⁻¹ and 1.17×10⁻¹, respectively. In Examples 11 and 12, r was 0 and inconspicuousness was poor.

In Examples 7 to 10, the gradation value n₁ of the first region was 232, |n₁−n₂| was equal to or smaller than 12, and F was equal to or smaller than 4.69×10⁻². In Examples 7 to 10, r was equal to or larger than 13.51%, and inconspicuousness was good or excellent. In Examples 9 and 10, in particular, |n₁−n₂| was equal to or smaller than 4, F was equal to or smaller than 1.56×10⁻², r was equal to or larger than 72.97%, and inconspicuousness was excellent.

In Example 13, the gradation value n₁ of the first region was 232, but |n₁−n₂| was 15, and F was 5.86×10⁻². In Example 13, r was 0, and inconspicuousness was poor.

According to Experiment Example 1 described above, in a case where the gradation value n₁ of the first region is 201, F is preferably equal to or larger than 0 and equal to or smaller than 1.09×10⁻¹, more preferably equal to or larger than 0 and equal to or smaller than 6.25×10⁻², even more preferably equal to or larger than 0 and equal to or smaller than 3.52×10⁻², and particularly preferably equal to or larger than 0 and equal to or smaller than 1.56×10⁻².

In a case where the gradation value n₁ of the first region is 232, F is preferably equal to or larger than 0 and equal to or smaller than 4.69×10⁻², and more preferably equal to or larger than 0 and equal to or smaller than 1.56×10⁻².

### Experiment Example 2: Relation Between (Dot Diameter/Dot Pitch) and Gradation Value in First Region

The inventors performed Experiment Example 2 to determine the relation between the dimension of the dot pattern and the gradation value of the first region.

### (Production of Specimen)

A total of 65 specimens including a dot pattern having a diameter of 70 μm to 120 μm and a pitch of 150 μm to 280 μm were produced. Note that dots were substantially circular.

### (Measurement of Specimen Diameter/Pitch)

Planar observation of a specimen piece was performed by using an electronic microscope (“Dino-Lite Edge AMR Polarizer (polarization)” manufactured by Opto Science, Inc.) to measure the diameter and pitch of dots at three places selected at random.

### (Measurement of Gradation Value)

An image of each specimen was captured by using iR-ADV C5235F manufactured by Canon Inc. as an optical reading apparatus to acquire a captured image. The reading resolution in this case was 400 dpi. Subsequently, the gradation value was measured at three places selected at random in the captured image by using Microsoft Paint of Microsoft Corporation. Then, the average of the gradation value over the three places selected at random was calculated as the gradation value of the specimen.

### (Evaluation Result)

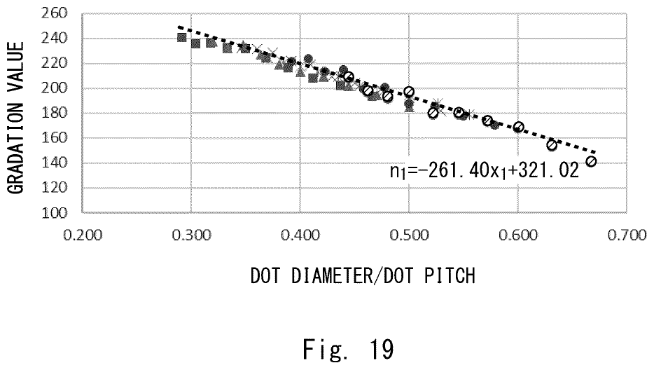

An evaluation result of Experiment Example 2 is illustrated in FIG. 19. FIG. 19 is a diagram illustrating the relation between (dot diameter/dot pitch) and the gradation value. The relation between diameter/pitch x₁, where x₁ represents (dot diameter/dot pitch), and the gradation value n₁ was expressed in a substantially linear shape as illustrated in FIG. 19. A regression line was calculated, and Expression (2) described above was obtained as the regression line.

Note that the dashed line illustrated in FIG. 19 is the regression line of the gradation value with (dot diameter/dot pitch).

In this manner, the inventors found that the gradation value n₁ of the second region included in the pseudo layer can be expressed with the ratio of the dot diameter and pitch.

### Experiment Example 3: Relation Between (Mesh Line Width/Mesh Pitch) and Gradation Value in Second Region

The inventors performed Experiment Example 3 to determine the relation between the dimension of the mesh pattern and the gradation value of the second region.

### (Production of Specimen)

A total of 10 specimens including a mesh pattern having a line width of 10 μm to 28 μm and a pitch of 274 μm to 548 μm were produced. Note that the opening shape of the mesh pattern was hexagonal.

### (Measurement of Specimen Line Width/Pitch)

Planar observation of a specimen piece was performed by using an electronic microscope (“Dino-Lite Edge AMR Polarizer (polarization)” manufactured by Opto Science, Inc.) to measure the mesh line width and pitch at three places selected at random.

### (Measurement of Gradation Value)

The gradation value of each specimen was measured as in Experiment Example 2.

### (Evaluation Result)

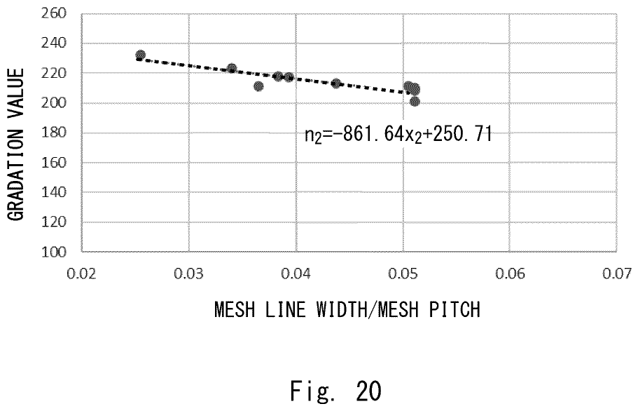

An evaluation result of Experiment Example 3 is illustrated in FIG. 20. FIG. 20 is a diagram illustrating the relation between (mesh line width/mesh pitch) and the gradation value. The relation between (mesh line width/mesh pitch) x₂, where x₂ represents (mesh line width/mesh pitch), and the gradation value n₂ was expressed in a substantially linear shape as illustrated in FIG. 20. A regression line was calculated, and Expression (3) described above was obtained as the regression line.

Note that the dashed line illustrated in FIG. 20 is the regression line of the gradation value with (mesh line width/mesh pitch).

In this manner, the inventors found that the gradation value n₂ of the second region included in the second conductor layer can be expressed with the ratio of the mesh line width and the mesh pitch.

### Experiment Example 4: Gradation Value and Antenna Performance

The inventors evaluated antenna performance with the gradation value n₂ of the second region to determine a preferable range of the gradation value n₂ of the second region from a viewpoint of antenna performance. In Experiment Example 4, the front-back ratio (FB ratio) was used as antenna performance.

### (Specimen)

A sheet with a mesh pattern of 500 mm in height, 600 mm in width, and 0.14 mm in thickness was used as a specimen. In each example, a sheet with the mesh pattern having a different gradation value n₂ was used as a specimen. Note that the specimen used in Example 14 of Experiment Example 4 was the same as the specimen used in Example 1 of Experiment Example 1.

### (Measurement of Gradation Value n₂)

The gradation value of each specimen was measured as in Experiment Example 2.

### (Calculation of (Mesh Line Width/Mesh Pitch) x₂)

Expression (3) was used to calculate x₂ from measured n₂.

### (Measurement of Antenna Performance)

The FB ratio was calculated based on a directionality measurement result by using an electromagnetic anechoic chamber. A frequency condition was 4550 MHz. A measured value was classified based on evaluation criteria described below, and antenna performance was evaluated. Table 2 lists results.

### <<Evaluation Criteria of Antenna Performance>>

Good: the measured value of the FB ratio is equal to or larger than 10 dB.

Fair: the measured value of the FB ratio is equal to or larger than 8 dB and smaller than 10 dB.

Poor: the measured value of the FB ratio is smaller than 8 dB.

TABLE 2

| | | | FB |
|---|---|---|---|
| | | | evaluation |
| Example | x₂ | n₂ | value |
| 14 | 4.61 × 10⁻² | 211 | Good |
| 15 | 3.91 × 10⁻² | 217 | Good |
| 16 | 2.17 × 10⁻² | 232 | Fair |
| 17 | 1.24 × 10⁻² | 240 | Fair |
| 18 | 3.15 × 10³ | 248 | Poor |

In Examples 14 and 15, (mesh line width/mesh pitch) x₂ was equal to or larger than 3.91×10⁻², the gradation value n₂ was equal to or larger than 211, and the FB ratio was equal to or larger than 10 dB. In Examples 16 and 17, x₂ was equal to or larger than 1.24×10⁻², the gradation value n₂ was equal to or larger than 232, and the FB ratio was equal to or larger than 8 dB.

In Example 18, x₂ was 3.15×10⁻³, n₂ was 248, and the FB ratio was poor.

According to Experiment Example 4 described above, x₂ is preferably equal to or larger than 5.47×10⁻³, more preferably equal to or larger than 1.24×10⁻², even more preferably equal to or larger than 2.17×10⁻², particularly preferably equal to or larger than 3.91×10⁻², and most preferably equal to or larger than 4.61×10⁻². In addition, n₂ is preferably equal to or smaller than 246, more preferably equal to or smaller than 240, even more preferably equal to or smaller than 232, particularly preferably equal to or smaller than 217, and most preferably equal to or smaller than 211. When n₂ is equal to or smaller than 246 or equal to or smaller than 217 in particular, the FB ratio is equal to or larger than 8 dB and thus antenna performance can be ensured.

The present invention is not limited to the above-described embodiments but may be modified as appropriate without departing from the scope thereof. For example, the pseudo layer, which is disposed entirely not overlapping the second conductor layer in a plan view, may partially overlap the second conductor layer.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. An antenna unit comprising:
a dielectric layer through which visible light transmits;
a first conductor layer;
a pseudo layer; and
a second conductor layer provided separately from the first conductor layer, wherein
the first conductor layer is provided on a first principal surface side of the dielectric layer with respect to the dielectric layer,
the second conductor layer is provided on the first principal surface side of the dielectric layer or a second principal surface side opposite to the first principal surface side with respect to the dielectric layer,
at least part of the pseudo layer is disposed around the second conductor layer in a plan view, and

|n₁−n₂|/N≤1.09×10⁻¹ holds where n₁ and n₂ (n₁ and n₂ are integers equal to or larger than zero) are N-level gradation values (N is a natural number) in a case where a first region that exists without overlapping the second conductor layer in the pseudo layer and a second region that exists without overlapping the pseudo layer in the second conductor layer in the plan view are read at a resolution of 400 dpi.

2. The antenna unit according to claim 1, wherein |n₁−n₂|/N≤6.25×10⁻² holds.

3. The antenna unit according to claim 1, where N=256 and n₂≤246 hold.

4. The antenna unit according to claim 1, wherein
The first conductor layer includes a radiative conductor,
the second conductor layer includes a ground conductor, and
the second conductor layer is provided on the second principal surface side of the dielectric layer with respect to the dielectric layer.

5. The antenna unit according to claim 1, wherein
the first conductor layer includes a radiative conductor,
the second conductor layer includes a ground conductor, and
the second conductor layer is provided on the first principal surface side of the dielectric layer with respect to the dielectric layer.

6. The antenna unit according to claim 1, wherein
the first conductor layer includes a ground conductor,
the second conductor layer includes a radiative conductor, and
the second conductor layer is provided on the second principal surface side of the dielectric layer with respect to the dielectric layer.

7. The antenna unit according to claim 1, wherein
the first conductor layer includes a radiative conductor,
the second conductor layer includes a waveguide element that guides electric waves radiated by the radiative conductor in a predetermined direction,
the second conductor layer is provided on the second principal surface side of the dielectric layer with respect to the dielectric layer, and
the antenna unit further includes a ground conductor layer provided on a side opposite to the dielectric layer with respect to the first conductor layer.

8. The antenna unit according to claim 1, wherein the pseudo layer includes a pattern in which array elements are arrayed separately from each other.

9. The antenna unit according to claim 8, wherein the array element has an electrical conductivity equal to or larger than 1×10⁶ (S/m).

10. The antenna unit according to claim 9, wherein
the array elements each have a circular shape, and
the array elements have an average diameter equal to or smaller than λ₀/2 where λ₀ is a free-space wavelength of electric waves transmitted and received by the antenna unit.

11. The antenna unit according to claim 9, wherein
the array elements each have a rectangular shape, and
the array elements each have a long side of a length equal to or smaller than λ₀/2 where λ₀ is a free-space wavelength of electric waves transmitted and received by the antenna unit.

12. The antenna unit according to claim 1, wherein
the pseudo layer is made of an insulator, and
the insulator has an electrical conductivity smaller than 1×10⁶ (S/m).

13. The antenna unit according to claim 1, wherein the second conductor layer includes a mesh-like conductor pattern.

14. A window glass comprising the antenna unit according to claim 1.
